(19) United States
(12) Patent Application Publication
(10) Pub. No.: US 2024/0245075 A1
(43) Pub. Date: Jul. 25, 2024

(54) Kind of plant protein-based fat analogue and its preparation and 3D/4D printing application

(71) Applicant: Jiangnan University, Wuxi (CN)

(72) Inventors: Zong Meng, Wuxi (CN); Shaoyang Li, Wuxi (CN)

(21) Appl. No.: 18/605,966

(22) Filed: Mar. 15, 2024

Related U.S. Application Data
(63) Continuation of application No. PCT/CN2022/098100, filed on Jun. 10, 2022.

(30) Foreign Application Priority Data
Sep. 15, 2021 (CN) 2021111028852
Dec. 13, 2021 (CN) 2021115607820
Mar. 10, 2022 (CN) 2022102297591

(51) Int. Cl. A23J 3/14; A23D 7/005; A23G 1/00; A23J 3/34

(52) U.S. Cl. CPC A23J 3/14; A23D 7/005; A23G 1/0006; A23J 3/34

(57) ABSTRACT

The present disclosure discloses vegetable protein-based fat analogue, preparation therefor and use thereof in 3D/4D printing, and belongs to the technical field of oil and emulsified fat products. In the present disclosure, a nanoscale pea/mung bean protein gel is prepared by combination of a thermal method/an enzymatic method first, and nanoscale microgel particles are obtained by high pressure homogenization/microfluidization treatment. Then, an O/W or W/O/W fat analogue system is obtained by a single-step/multi-step emulsification method, subjected to property improvement by adjusting an oil phase proportion, the type of polysaccharide for compounding and the like, and used in 3D food printing. Finally, conventional cocoa butter, a cocoa butter equivalent or a cocoa butter substitute in chocolate is substituted to different degrees to construct chocolate pastes with different thermodynamic properties, and spontaneous changes, namely 4D printing, of a 3D printing structure of the chocolate overtime are achieved by thermal induction.

### TECHNICAL FIELD

The present disclosure relates to vegetable protein-based fat analogue, preparation therefor and use thereof in 3D/4D printing, and belongs to the technical field of oil and emulsified fat products.

### BACKGROUND

Many natural and processed foods are composed of multi-phase dispersion systems of foams, emulsions and the like (such as milk, cream, salad dressings, beer and ice cream). Due to bubbles, oil droplets, solid particles and other structures, the food systems have high specific surface areas, and have a series of macroscopic behaviors (such as rheological properties, structures and stability) that are greatly dependent on two-phase interface properties. These food systems are called “interface dominated food systems”. In recent years, with economic development and improvement of living standards, questions have been raised about the safety of interface dominated foods stabilized by low-molecular-weight surfactants (LWSFs), more and more consumers pursue more natural and green foods, and foods stabilized by natural macromolecules (such as protein, edible gum and other substances) rather than the LWSFs are increasingly favored by consumers.

A class of stable solid particles can be obtained by using natural macromolecules such as protein or edible gum after a series of pretreatment. Compared with stability mechanisms of the low-molecular-weight surfactants and conventional natural macromolecules, such solid particles have more stable adsorption on an interface. Not only can the total free energy of a system be reduced by reducing interfacial tension, but also a barrier with a space structure is formed on the interface due to the adsorption of solid particles, and collision between droplets is prevented, such that the obtained system is more stable.

Pea protein has a high nutritional value, a biological value (BV) of 48-64%, and a protein efficiency ratio (PER) of 0.6-1.2, which are higher than those of soybean protein. Meanwhile, the pea protein is rich in lysine, arginine and branched chain amino acids, where the arginine has a content of about 8.7%, which is conducive to immunity improvement, muscle building, brain strengthening, memory improvement and other effects. Mung beans have a protein content of about 19.5-33.1% and an average protein content of 21.6%, which is slightly lower than that of soybean protein, but is higher than that of other common grain proteins. Moreover, mung bean protein is not a major food allergen. Therefore, the mung bean protein is a very beneficial food as a protein source. However, both peas and mung beans have weak gel properties, which can only form weak gels and are difficult to prepare stable solid particles for stable structural oil systems compared with the soybean protein and the like.

In addition, use of vegetable protein, polysaccharide and other macromolecular substances to structuralize liquid vegetable oil has become a hot topic in recent years, including use of a Pickering mechanism to construct stable emulsion systems. Different from conventional systems, such emulsions have a stronger interfacial adsorption effect and can be approximately regarded as staying in a non-desorption state after adsorption, so that long-term stability of the emulsions is effectively ensured. By using the method, the vegetable oil can be structuralized, which can be further used as a substitute for conventional solid fat.

A 3D printing technology, also known as additive manufacturing (AM), integrates computer aided design and a material processing and molding technology, and includes designing a 3D model by using digital model software, generating several layers of corresponding three-dimensional slices by slicing software, calculating a path of each layer of slice by using programming G codes, and finally inputting the path to a printing device. The device identifies the codes, a nozzle moves according to the preset path to extrude a printing material at a specified rate, and a product with a three-dimensional structure is constructed by stacking the material layer by layer.

Since 3D printing can be conveniently customized and has an ultrahigh degree of freedom, the 3D printing technology has been rapidly developed in aerospace, biomedicine and other areas in need since development. Meanwhile, due to the development of 3D printing materials in recent years, more and more soft materials have been used in the 3D printing technology, and 3D food printing has also been developed unprecedentedly. However, as materials required for foods have poorer printing performance than inorganic materials or metal materials, a large number of food materials are heterogeneous systems. Therefore, these materials are difficult to be directly used in printing, and development fields of the 3D food printing are limited to a certain extent.

4D printing refers to use of 3D printed structures (such 3D printed products are usually multi-structure products formed by dual-channel printing using different raw materials) to enable changes in physical and chemical properties under certain stimulus conditions (such as temperature, humidity, light, magnetic field and the like), and such changes are usually changes of one or more of shape, color and flavor. In the field of food, the appearance can be changed after thermal induction, so that the food has a richer visual effect, and diversification, customization and interest of such products are realized. At present, the 4D printing is mainly used in materials with starch as a main component, and causes for induced deformation basically include curved structures caused by a high temperature dehydration effect and the like. A chocolate system is a product constructed from protein-based stable liquid vegetable oil and has more complex composition, and the 4D printing not only requires certain melting point differences between two materials, but also needs to achieve better printing strength. Therefore, it is more difficult to prepare chocolate by the 4D printing.

### SUMMARY

### Technical Problems

At present, vegetable protein used for preparing microgel particles for stable fat analogue systems mainly include soybean protein, peanut protein and other proteins having strong gel properties, peas and mung beans are difficult to construct stable systems due to weak gel properties, and the weak gel properties lead to unstable microgel particles formed thereby, which further affect the construction of stable gelatinized fat systems.

A method for substituting conventional fat with liquid vegetable oil by a 3D printing technology has not been systematically studied due to certain difficulty in technical means and the need to substitute fat so as to achieve better printing strength.

4D printing not only requires certain property differences between two materials to ensure that spontaneous changes can be achieved over time under certain conditions, but also requires the materials to have better printing strength when used in the food industry, so that no documents about construction of chocolate systems by substituting cocoa butter with liquid vegetable oil using a 4D printing technology have been disclosed at present.

### Technical Solutions

In order to solve at least one of the above problems, from the perspective of molecular interaction and nutrition and health in the present disclosure, fat substitutes with no trans-fatty acids, low-saturation fatty acids, good stability, high plasticity and other properties are prepared by a method of obtaining nanoscale solid particles based on multi-functionality (such as emulsification and gelatinization) of natural macromolecules and high pressure homogenization treatment under simple process conditions.

The first purpose of the present disclosure is to provide a method for preparing a healthy fat substitute based on pea/mung bean protein, which includes the following steps:
(1) preparing a protein isolate solution with a mass concentration of 5-20%, and performing hydration to obtain a hydrated protein isolate solution, where the protein isolate is a pea protein isolate or a mung bean protein isolate;
(2) subjecting the hydrated protein isolate solution obtained in step (1) to high-speed shearing and high-pressure homogenization to obtain a nanoscale protein isolate dispersion solution;
(3) subjecting the nanoscale protein isolate dispersion solution in step (2) to heating treatment to obtain a modified protein isolate dispersion solution;
(4) adding transglutaminase into the protein isolate dispersion solution in step (3) to carry out a reaction so as to obtain a protein isolate gel;
(5) adding a diluent into the protein isolate gel in step (4), and performing microfluidization and high-pressure homogenization to obtain a nanoscale microgel solution;
(6) adding a gelatinized nanogel dispersion solution obtained in step (5) into edible oil, and performing high-speed shearing treatment to obtain a gelatinized fat substitute.

In an embodiment of the present disclosure, in step (1), a solvent of the protein isolate solution includes one or both of a phosphate buffer and water; the hydration includes placing the protein isolate solution at low temperature for hydration; and the low temperature includes refrigeration at 1-10° C. for 10-18 h, preferably refrigeration at 1-4° C. for 12-16 h.

In an embodiment of the present disclosure, in step (2), the high-speed shearing is performed at 5,000-15,000 rpm for 1-3 min.

In an embodiment of the present disclosure, in step (2), the high-pressure homogenization is performed at 20-100 MPa for 1-4 min.

In an embodiment of the present disclosure, in step (3), the heating treatment is performed at 80-90° C. for 30-60 min to obtain a protein solution with an extended structure and better hydrophobic properties.

In an embodiment of the present disclosure, in step (4), the pH value needs to be adjusted to 6.2-7.3 before the reaction, preferably 6.7-7.1, protein dispersion is facilitated in the range, and a gel network is formed more easily through crosslinking of amino acid residues.

In an embodiment of the present disclosure, in step (4), an added amount of the transglutaminase is 2-10 U/g, and reaction conditions include: low temperature crosslinking at 30-45° C. for 2-4 h, and then heating in a water bath at 85-100° C. for 5-20 min to obtain a protein gel, so that an isopeptide bond is formed between Lys and Gln, and the protein gel is constructed and formed.

In an embodiment of the present disclosure, in step (5), the diluent includes one or both of a phosphate buffer and water, and a mass ratio of the diluent to the protein isolate gel is 2:1.

In an embodiment of the present disclosure, in step (5), the microfluidization is performed at 20-200 MPa for 2-4 min.

In an embodiment of the present disclosure, in step (5), the high-pressure homogenization is performed at 60-100 MPa for 1-4 min.

In an embodiment of the present disclosure, in step (6), the edible oil includes one or more of soybean oil, rapeseed oil, peanut oil, sunflower oil, rice bran oil, corn oil, linseed oil, olive oil, wheat germ oil, cottonseed oil, almond oil, tea seed oil and sesame oil, and a mass percentage of the edible oil in the nanogel dispersion solution obtained in step (5) is 10-90%, preferably 30-70%.

In an embodiment of the present disclosure, in step (6), the high-speed shearing is performed at 5,000-15,000 rpm for 1-2 min.

In an embodiment of the present disclosure, a mass concentration of a protein isolate in the fat substitute obtained in step (6) is 0.2-5%.

The second purpose of the present disclosure is to provide a healthy fat substitute based on pea/mung bean protein prepared by the method of the present disclosure.

The third purpose of the present disclosure is to provide a method for preparing a healthy fat substitute based on pea/mung bean protein-edible gum, which includes the following steps:

steps (1)-(5): performing the same operations as those in steps (1)-(5) in the method for preparing a healthy fat substitute based on pea/mung bean protein of the present disclosure;

(6) preparing an edible gum solution with a mass concentration of 0.02-1%;

(7) mixing a gelatinized nanogel dispersion solution obtained in step (5) with the edible gum solution obtained in step (6), and performing dilution and shearing treatment to obtain a preliminary mixing system of pea/mung bean nanogel particles and edible gum; and then treating the preliminary mixing system of nanogel particles and edible gum by microfluidization or high-pressure homogenization to obtain a nanogel particle-edible gum dispersion system; and

(8) adding the nanogel particle-edible gum dispersion system obtained in step (7) into edible oil, and performing high-speed shearing treatment to obtain a gelatinized fat substitute.

In an embodiment of the present disclosure, in step (6), the edible gum is obtained by compounding one or more of guar gum, Arabic gum, carrageenan, xanthan gum and locust bean gum, and is preferably obtained by adding xanthan gum and/or carrageenan.

In an embodiment of the present disclosure, in step (6), a solvent of the edible gum solution is water.

In an embodiment of the present disclosure, in step (7), a volume ration of the gelatinized nanogel dispersion solution obtained in step (5) to the edible gum solution obtained in step (6) is 1:1.

In an embodiment of the present disclosure, in step (7), a diluent used in the dilution includes one or both of a phosphate buffer and water, and a mass of the diluent is 2 times that of a mixed solution formed by the gelatinized nanogel dispersion solution obtained in step (5) and the edible gum solution obtained in step (6).

In an embodiment of the present disclosure, in step (7), the shearing treatment is performed at 5,000-15,000 rpm for 1-5 min.

In an embodiment of the present disclosure, in step (7), the microfluidization is performed at 10-100 MPa, and the high-pressure homogenization is performed at 20-80 MPa for 2-4 min.

In an embodiment of the present disclosure, in step (8), the edible oil includes one or more of soybean oil, rapeseed oil, peanut oil, sunflower oil, rice bran oil, corn oil, linseed oil, olive oil, wheat germ oil, cottonseed oil, almond oil, tea seed oil and sesame oil, and a mass percentage of the edible oil in the nanogel particle-edible gum dispersion system obtained in step (8) is 10-90%, preferably 30-70%.

In an embodiment of the present disclosure, in step (8), the high-speed shearing is performed at 5,000-15,000 rpm for 1-2 min.

In an embodiment of the present disclosure, a mass concentration of the protein isolate in the fat substitute obtained in step (8) is 0.2-5%.

The fourth purpose of the present disclosure is to provide a healthy fat substitute based on pea/mung bean protein-edible gum prepared by the method of the present disclosure.

The fifth purpose of the present disclosure is to provide use of the healthy fat substitute based on pea/mung bean protein or the healthy fat substitute based on pea/mung bean protein-edible gum of the present disclosure in decoration.

In an embodiment of the present disclosure, the use includes uniformly extruding the healthy fat substitute based on pea/mung bean protein or the healthy fat substitute based on pea/mung bean protein-edible gum of the present disclosure through a decorating opening to obtain a shape with a certain supporting structure.

In an embodiment of the present disclosure, the decorating opening has a diameter of 2-5 mm.

In addition, through multiple emulsification in the present disclosure, an unstable W/O system obtained by single emulsification becomes a dispersed phase through secondary emulsification, and the content of an oil phase in the system is further reduced by using the W/O/W system, so that double-emulsified W/O/W fat analogue with a better 3D printing effect can be obtained at a lower volume fraction of the oil phase. Moreover, the double-emulsified W/O/W fat analogue of the present disclosure is different from a common Pickering emulsion with a high internal phase. For the common Pickering emulsion, the viscosity and energy storage modulus of the emulsion are increased by using a higher volume fraction of the internal phase.

The sixth purpose of the present disclosure is to provide a method for preparing double-emulsified W/O/W fat analogue capable of being used in 3D printing based on vegetable protein, which includes the following steps:

(1) preparing a protein isolate solution with a mass concentration of 5-20%, and performing hydration to obtain a hydrated protein isolate solution, where the protein isolate includes one or more of a peanut protein isolate, a pea protein isolate and a mung bean protein isolate;

(2) subjecting the hydrated protein isolate solution obtained in step (1) to high-speed shearing and high-pressure homogenization to obtain a nanoscale protein isolate dispersion solution;

(3) subjecting the nanoscale protein isolate dispersion solution in step (2) to heating treatment to obtain a modified protein isolate dispersion solution;

(4) adding transglutaminase (TGase) into the protein isolate dispersion solution in step (3) to carry out a reaction so as to obtain a protein isolate gel;

(5) adding a diluent into the protein isolate gel in step (4), and performing microfluidization and high-pressure homogenization to obtain a nanoscale microgel solution;

(6) adding a gelatinized nanogel dispersion solution obtained in step (5) into liquid edible vegetable oil, and performing high-speed shearing treatment to obtain a W/O system emulsion, where the liquid edible vegetable oil is a continuous phase, and the gelatinized nanoscale microgel dispersion solution is a dispersed phase;

(7) performing secondary emulsification by using the W/O emulsion obtained in step (6) as a whole as a dispersed phase and the gelatinized nanoscale microgel dispersion solution obtained in step (5) as a continuous phase, and performing high-speed shearing treatment to obtain double-emulsified W/O/W fat analogue.

In an embodiment of the present disclosure, in step (1), a solvent of the protein isolate solution includes one or both of a phosphate buffer and water; the hydration includes placing the protein isolate solution at low temperature for hydration; and the low temperature includes refrigeration at 1-10° C. for 10-18 h, preferably refrigeration at 1-4° C. for 12-16 h.

In an embodiment of the present disclosure, in step (2), the high-speed shearing is performed at 5,000-15,000 rpm for 1-3 min.

In an embodiment of the present disclosure, in step (2), the high-pressure homogenization is performed at 20-100 MPa for 1-4 min.

In an embodiment of the present disclosure, in step (3), the heating treatment is performed at 80-90° C. for 30-60 min to obtain a protein solution with an extended structure and better hydrophobic properties.

In an embodiment of the present disclosure, in step (4), the pH value needs to be adjusted to 6.2-7.3 before the reaction, preferably 6.7-7.1, protein dispersion is facilitated in the range, and a gel network is formed more easily through crosslinking of amino acid residues.

In an embodiment of the present disclosure, in step (4), an added amount of the transglutaminase (TGase) is 2-10 U/g, and reaction conditions include: low temperature crosslinking at 30-45° C. for 2-4 h, and then heating in a water bath at 85-100° C. for 5-20 min to obtain a protein gel, so that an isopeptide bond is formed between Lys and Gln, and the protein gel is constructed and formed.

In an embodiment of the present disclosure, in step (5), the diluent includes one or both of a phosphate buffer and water, and a mass ratio of the diluent to the protein isolate gel is 2:1.

In an embodiment of the present disclosure, in step (5), the microfluidization is performed at 20-200 Mpa for 2-4 min.

In an embodiment of the present disclosure, in step (5), the high-pressure homogenization is performed at 60-100 MPa for 1-4 min.

In an embodiment of the present disclosure, in step (6), the edible vegetable oil includes one or more of soybean oil, rapeseed oil, peanut oil, sunflower oil, rice bran oil, corn oil, linseed oil, olive oil, wheat germ oil, cottonseed oil, almond oil, tea seed oil and sesame oil, and a mass percentage of the vegetable oil in the nanogel dispersion solution obtained in step (5) is 70-90%, preferably 75-85%.

In an embodiment of the present disclosure, in step (6), the high-speed shearing is performed at 5,000-15,000 rpm for 1-2 min.

In an embodiment of the present disclosure, a mass concentration of the protein isolate in the W/O system obtained in step (6) is 0.2-5%.

In an embodiment of the present disclosure, in step (7), a volume ratio of the dispersed phase to the continuous phase is (40-70):(30-60), further preferably (50-60):(40-50).

In an embodiment of the present disclosure, in step (7), the high-speed shearing is performed at 5,000-15,000 rpm for 1-3 min.

In an embodiment of the present disclosure, a mass concentration of a nanoscale microgel in the continuous phase of the double-emulsified W/O/W fat analogue obtained in step (7) is 0.2-2%.

The seventh purpose of the present disclosure is to provide double-emulsified W/O/W fat analogue based on vegetable protein prepared by the method of the present disclosure.

The eighth purpose of the present disclosure is to provide a method for preparing double-emulsified W/O/W fat analogue capable of being used in 3D printing based on compounding of vegetable protein and polysaccharide, which includes the following steps:

steps (1)-(5): performing the same operations as those in steps (1)-(5) in the method for preparing double-emulsified W/O/W fat analogue capable of being used in 3D printing based on vegetable protein of the present disclosure;

(6) preparing a polysaccharide solution with a mass concentration of 0.02-2%;

(7) mixing a gelatinized nanogel dispersion solution obtained in step (5) with the polysaccharide solution obtained in step (6), adding water for dilution, and performing treatment by a shearing machine at 5,000-15,000 rpm for 1-5 min to obtain a preliminary mixing system of protein nanogel particles and polysaccharide; and further treating the mixing system of nanogel particles and polysaccharide by microfluidization or a high pressure homogenizer at 20-80 MPa to obtain a stable protein nanogel particle-polysaccharide dispersion system;

(8) adding a protein-polysaccharide mixed solution obtained in step (7) into liquid vegetable oil, where a protein microgel has a mass concentration of 0.2-5%, the polysaccharide has a mass concentration of 0.01-1%, and an oil phase has a mass fraction of 70-90%; and performing high-speed shearing treatment at 5,000-15,000 rpm for 1-2 min to obtain a W/O system;

(9) performing secondary emulsification by using a W/O emulsion obtained in step (8) as a whole as a dispersed phase and the gelatinized nanoscale microgel dispersion solution obtained in step (7) as a continuous phase, and performing high-speed shearing treatment to obtain W/O/W fat analogue.

In an embodiment of the present disclosure, in step (6), the edible gum is obtained by compounding one or more of guar gum, Arabic gum, carrageenan, xanthan gum and locust bean gum, and is preferably obtained by adding xanthan gum and/or carrageenan.

In an embodiment of the present disclosure, in step (6), a solvent of the edible gum solution is water.

In an embodiment of the present disclosure, in step (7), a volume ration of the gelatinized nanogel dispersion solution obtained in step (5) to the edible gum solution obtained in step (6) is 1:1.

In an embodiment of the present disclosure, in step (7), a diluent used in the dilution includes one or both of a phosphate buffer and water, and a mass of the diluent is 2 times that of a mixed solution formed by the gelatinized nanogel dispersion solution obtained in step (5) and the edible gum solution obtained in step (6).

In an embodiment of the present disclosure, in step (7), the shearing treatment is performed at 5,000-15,000 rpm for 1-5 min.

In an embodiment of the present disclosure, in step (7), the microfluidization is performed at 10-100 MPa, and the high pressure homogenization is performed at 20-80 MPa for 2-4 min.

In an embodiment of the present disclosure, in step (8), the edible oil includes one or more of soybean oil, rapeseed oil, peanut oil, sunflower oil, rice bran oil, corn oil, linseed oil, olive oil, wheat germ oil, cottonseed oil, almond oil, tea seed oil and sesame oil, and a mass percentage of the edible oil in the nanogel particle-edible gum dispersion system obtained in step (8) is 10-90%, preferably 30-70%.

In an embodiment of the present disclosure, in step (8), the high-speed shearing is performed at 5,000-15,000 rpm for 1-2 min.

In an embodiment of the present disclosure, a mass concentration of the protein isolate in the fat substitute obtained in step (8) is 0.2-5%.

In an embodiment of the present disclosure, in step (9), a volume ratio of the dispersed phase to the continuous phase is (40-70):(30-60), further preferably (50-60):(40-50).

In an embodiment of the present disclosure, in step (9), the high-speed shearing is performed at 5,000-15,000 rpm for 1-3 min.

The ninth purpose of the present disclosure is to provide double-emulsified W/O/W fat analogue based on compounding of vegetable protein and polysaccharide prepared by the method of the present disclosure.

The tenth purpose of the present disclosure is to provide use of the double-emulsified W/O/W fat analogue based on vegetable protein and the double-emulsified W/O/W fat analogue based on compounding of vegetable protein and polysaccharide of the present disclosure in 3D printing.

In an embodiment of the present disclosure, the use includes the following steps:

(1) filling the double-emulsified W/O/W fat analogue based on vegetable protein or the double-emulsified W/O/W fat analogue based on compounding of vegetable protein and polysaccharide of the present disclosure into a 3D printing needle tube to ensure that the system in the needle tube is uniform and not dispersed;

(2) adjusting the temperature in a printing chamber, selecting a 3D printing gun head for filling, and adjusting X, Y and Z axes of a 3D printer to zero by program setting;

(3) designing a 3D model by using digital model software, generating several layers of corresponding three-dimensional slices by slicing software to obtain a slice model, calculating a path of each layer of slice by using programming G codes, and finally inputting the path to a printing device;

(4) setting various parameters in a 3D printing process according to different materials and selected needle diameters, specifically including: printing layer thickness, wall thickness, filling density, bottom and top layer thickness, printing rate and the like;

(5) performing 3D food printing by an extrusion method using the device according to the imported slice model in step (3) to form a customized model with certain self-supporting properties.

In an embodiment of the present disclosure, in step (1), the 3D printing needle tube used has a capacity of 50 mL, and a PVC plastic or aluminum needle tube may be used according to different use temperatures.

In an embodiment of the present disclosure, in step (2), the internal temperature of the printing chamber is adjusted according to different mass percentages of an oil phase, and the temperature is set in the range of 0-40° C., preferably 10-25° C.

In an embodiment of the present disclosure, in step (3), the digital model software used is a 3ds Max 2020 version, and the exported 3D model is in an obj format; and the slicing software used is a Cura15.02.1 version, and sliced files are in a gcode format.

In an embodiment of the present disclosure, in step (4), the printing parameters are specifically as follows: a printing layer thickness is 0.2-0.4 mm, a wall thickness is 0.4-1.2 mm, a filling density is 10-60%, a bottom and top layer thickness is 0.2-1.2 mm, a printing rate is 40-120 mm/s, a printing temperature is 0-30° C., an initial layer thickness is 0.2-0.8 mm, an initial layer line width is 10-80%, a bottom layer cut thickness is 0 mm, a moving rate is 20-200 mm/s, a bottom layer rate is 20-120 mm/s, a filling rate is 20-120 mm/s, a bottom and top layer rate is 20-100 mm/s, a shell rate is 20-120 mm/s, and an inner wall rate is 10-80 mm/s.

The eleventh purpose of the present disclosure is to provide a method for preparing 3D printed chocolate by using the double-emulsified W/O/W fat analogue based on vegetable protein or the double-emulsified W/O/W fat analogue based on compounding of vegetable protein and polysaccharide of the present disclosure to substitute cocoa butter, which includes the following steps:

(1) dissolving the double-emulsified W/O/W fat analogue based on vegetable protein or the double-emulsified W/O/W fat analogue based on compounding of vegetable protein and polysaccharide and solid cocoa butter; and then performing mixing with cocoa powder, powdered sugar and soybean lecithin and grinding to form a stable chocolate paste system;

(2) dissolving the obtained chocolate paste, and performing 3D printing to obtain 3D printed chocolate.

In an embodiment of the present disclosure, in step (1), a mass ratio of the double-emulsified W/O/W fat analogue to the cocoa butter is (0-100%):(0-100%), further preferably (50-75%):(25-50%).

In an embodiment of the present disclosure, in step (1), the dissolving includes dissolving in a water bath, and a temperature of the water bath is 50-90° C., preferably further 60-70° C.

In an embodiment of the present disclosure, in step (1), an added proportion of the cocoa powder is 10-30%, an added proportion of the powdered sugar is 40-50%, an added proportion of the cocoa butter and the double-emulsified W/O/W fat analogue is 30-40%, and an added amount of the soybean lecithin is 0.5%, where the “%” refers to mass percentage.

In an embodiment of the present disclosure, in step (2), the 3D printing includes the following steps:
(1) filling the dissolved chocolate paste into a 3D printing needle tube with a capacity of 100 mL to ensure that the system in the needle tube is uniform and not dispersed;
(2) adjusting the temperature in a printing chamber to 25-50° C., selecting a 3D printing gun head for filling, and adjusting X, Y and Z axes of a 3D printer to zero by program setting;
(3) designing a printing model by using 3ds Max digital model software, generating several layers of corresponding three-dimensional slices by cura slicing software to obtain a slice model, calculating a path of each layer of slice by using programming G codes, and finally inputting the path to a printing device;
(4) setting various parameters in a 3D printing process, which are specifically as follows: a printing layer thickness is 0.2-0.4 mm, a wall thickness is 0.4-1.2 mm, a filling density is 10-60%, a bottom and top layer thickness is 0.2-1.2 mm, a printing rate is 40-120 mm/s, a printing temperature is 0-30° C., an initial layer thickness is 0.2-0.8 mm, an initial layer line width is 10-80%, a bottom layer cut thickness is 0 mm, a moving rate is 20-200 mm/s, a bottom layer rate is 20-120 mm/s, a filling rate is 20-120 mm/s, a bottom and top layer rate is 20-100 mm/s, a shell rate is 20-120 mm/s, and an inner wall rate is 10-80 mm/s;
(5) performing 3D printing by using the device according to the imported slice model to form a customized model with certain self-supporting properties.

The twelfth purpose of the present disclosure is to provide 3D printed chocolate prepared by the method of the present disclosure.

In addition, solid fat with excellent physical properties is obtained by using vegetable protein to stabilize liquid vegetable oil with different internal phases in the present disclosure, and water-containing chocolate products with similar properties to conventional chocolate are obtained by adjusting different cocoa butter substitute proportions. In the present disclosure, multi-structure and low-fat water-containing chocolate is obtained by using a dual-channel 3D printing technology first, and then a constructed multi-layer and multi-system structure is printed based on different thermodynamic properties of the water-containing chocolate, so that morphological changes, namely 4D printing effects, under stable external environment conditions are achieved.

The thirteenth purpose of the present disclosure is to provide a method for achieving dual-channel 4D printing of multi-structure and low-fat chocolate by induced deformation, which includes the following steps:

(1) preparation of a first chocolate paste:
evenly mixing W/O/W fat analogue with cocoa butter, a cocoa butter equivalent or a cocoa butter substitute at a mass ratio of 1:(1.1-10); and then adding an auxiliary material, and performing grinding to obtain a first paste system;

(2) preparation of a second chocolate paste:
evenly mixing W/O/W fat analogue with cocoa butter, a cocoa butter equivalent or a cocoa butter substitute at a mass ratio of 1:(0.1-1); and then adding an auxiliary material, and performing grinding to obtain a second paste system;

(3) 4D printing:
filling the first chocolate paste into a printing tube, filling the second chocolate paste into another printing tube, and performing dual-channel printing to obtain a chocolate model; and placing the chocolate model in an environment for thermally induced deformation at 30-36° C. for 30-120 s to achieve melting of chocolate in an outer layer so as to achieve 4D printing.

A preparation method for the W/O/W fat analogue includes the following steps:
(1) preparing a protein isolate solution with a mass concentration of 5-20%, and performing hydration to obtain a hydrated protein isolate solution, where the protein isolate includes one or more of a peanut protein isolate, a pea protein isolate, a mung bean protein isolate and a soybean protein isolate;
(2) subjecting the hydrated protein isolate solution obtained in step (1) to high-speed shearing and high-pressure homogenization to obtain a nanoscale protein isolate dispersion solution;
(3) subjecting the nanoscale protein isolate dispersion solution in step (2) to heating treatment to obtain a modified protein isolate dispersion solution;
(4) adding transglutaminase (TGase) into the protein isolate dispersion solution in step (3) to carry out a reaction so as to obtain a protein isolate gel;
(5) adding a diluent into the protein isolate gel in step (4), and performing microfluidization and high-pressure homogenization to obtain a nanoscale microgel solution;
(6) adding a gelatinized nanogel dispersion solution obtained in step (5) into liquid edible vegetable oil, and performing high-speed shearing treatment to obtain a W/O system emulsion, where the liquid edible vegetable oil is a continuous phase, and the gelatinized nanoscale microgel dispersion solution is a dispersed phase;
(7) performing secondary emulsification by using the W/O emulsion obtained in step (6) as a whole as a dispersed phase and the gelatinized nanoscale microgel dispersion solution obtained in step (5) as a continuous phase, and performing high-speed shearing treatment to obtain double-emulsified W/O/W fat analogue.

In an embodiment of the present disclosure, in step (1), the first chocolate paste is a low-melting-point chocolate paste with a melting point range of 26-32° C.

In an embodiment of the present disclosure, in step (2), the second chocolate paste is a high-melting-point chocolate paste with a melting point range of 33-38° C.

In an embodiment of the present disclosure, in step (1), the auxiliary material includes cocoa powder/milk powder, powdered sugar and soybean lecithin; and a mass ratio of the cocoa butter, the cocoa butter equivalent or the cocoa butter substitute in the first chocolate paste, the cocoa powder/milk powder, the powdered sugar and the soybean lecithin is 1:(0.05-0.2):(0.1-0.5):(0.001-0.01).

In an embodiment of the present disclosure, in step (2), the auxiliary material includes cocoa powder, powdered sugar and soybean lecithin; and a mass ratio of the cocoa butter, the cocoa butter equivalent or the cocoa butter substitute in the second chocolate paste, the cocoa powder, the powdered sugar and the soybean lecithin is 1:(0.4-2):(0.5-3):(0.001-0.1).

In an embodiment of the present disclosure, in steps (2) and (1), the cocoa butter equivalent includes one or more of shea butter, sal fat, mango kernel fat, kokum kernel fat, palm midfraction and illipe butter; and the cocoa butter substitute includes one or more of a lauric acid cocoa butter substitute and a non-lauric acid cocoa butter substitute.

In an embodiment of the present disclosure, the grinding in steps (2) and (1) includes adding the materials into a fine grinding cylinder, adding a grinding bead, and performing fine grinding by a twin-shaft refiner at a rotation speed of 1,000-1,500 rpm at room temperature for 2-3 h, and the chocolate paste is determined by a fineness tester to have a fineness of less than 25 μm.

In an embodiment of the present disclosure, in step (3), the 3D printing needle tube used has a capacity of 20-100 mL, and a PVC plastic or aluminum needle tube may be used according to different use temperatures.

In an embodiment of the present disclosure, in step (3), the chocolate model is a multi-layer and multi-structure chocolate model with the two chocolate pastes interpenetrating with each other.

In an embodiment of the present disclosure, in step (3), the first (low-melting-point) paste in the chocolate model constitutes an external structure; and the second (high-melting-point) paste constitutes an internal structure.

In an embodiment of the present disclosure, in step (3), the dual-channel printing specifically includes:
adjusting the temperature in a printing chamber, selecting a 3D printing gun head for filling, and adjusting X, Y and Z axes of a 3D printer to zero by program setting;
designing a 3D model by using digital model software, generating several layers of corresponding three-dimensional slices by slicing software to obtain a slice model, calculating a path of each layer of slice by using programming G codes, and finally inputting the path to a printing device;
setting various parameters in a 3D printing process according to different materials and selected needle diameters; and
performing 3D printing by an extrusion method using the device according to the imported slice model to form a customized model, namely the chocolate model, with certain self-supporting properties.

The internal temperature of the printing chamber is adjusted according to different liquid vegetable oils, cocoa butter, cocoa butter equivalents or cocoa butter substitutes and mass percentages thereof, and the temperature is set in the range of 0-40° C., preferably 20-25° C.

The digital model software used is a 3ds Max 2020 version, where the exported 3D model is in an stl format, the slicing software used is a Repetier-host version, and sliced files are in a gcode format.

The printing parameters are specifically as follows: a printing layer thickness is 0.2-1.2 mm, a wall thickness is 0.4-1.2 mm, a filling density is 10-60%, a bottom and top layer thickness is 0.2-1.2 mm, a printing rate is 40-120 mm/s, a printing temperature is 0-40° C., an initial layer thickness is 0.2-0.8 mm, an initial layer line width is 10-80%, a bottom layer cut thickness is 0 mm, a moving rate is 20-200 mm/s, a bottom layer rate is 20-120 mm/s, a filling rate is 20-120 mm/s, a bottom and top layer rate is 20-100 mm/s, a shell rate is 20-120 mm/s, and an inner wall rate is 10-80 mm/s.

An offset value of a distance between two printing heads of a dual-channel printer needs to set at 64 mm, and 0-3 upper solid layers and 0-3 lower solid layers are set.

In an embodiment of the present disclosure, in the preparation method for the W/O/W fat analogue, in step (1), a solvent of the protein isolate solution includes one or both of a phosphate buffer and water; the hydration includes placing the protein isolate solution at low temperature for hydration; and the low temperature includes refrigeration at 1-10° C. for 10-18 h, preferably refrigeration at 1-4° C. for 12-16 h;
in step (2), the high-speed shearing is performed at 5,000-15,000 rpm for 1-3 min; and the high-pressure homogenization is performed at 20-100 MPa for 1-4 min;
in step (3), the heating treatment is performed at 80-90° C. for 30-60 min to obtain a protein solution with an extended structure and better hydrophobic properties;
in step (4), the pH value needs to be adjusted to 6.2-7.3 before the reaction, preferably 6.7-7.1, protein dispersion is facilitated in the range, and a gel network is formed more easily through crosslinking of amino acid residues; in step (4), an added amount of the transglutaminase (TGase) is 2-10 U/g, and reaction conditions include: low temperature crosslinking at 30-45° C. for 2-4 h, and then heating in a water bath at 85-100° C. for 5-20 min to obtain a protein gel, so that an isopeptide bond is formed between Lys and Gln, and the protein gel is constructed and formed;
in step (5), the diluent includes one or both of a phosphate buffer and water, and a mass ratio of the diluent to the protein isolate gel is 2:1; the microfluidization is performed at 20-200 Mpa for 2-4 min; and the high-pressure homogenization is performed at 60-100 MPa for 1-4 min;
in step (6), the edible vegetable oil includes one or more of soybean oil, rapeseed oil, peanut oil, sunflower oil, rice bran oil, corn oil, linseed oil, olive oil, wheat germ oil, cottonseed oil, almond oil, tea seed oil and sesame oil, and a mass percentage of the vegetable oil in the nanogel dispersion solution obtained in step (5) is 70-90%; the high-speed shearing is performed at 5,000-15,000 rpm for 1-2 min; and a mass concentration of the protein isolate in the obtained W/O system is 0.2-5%;
in step (7), a volume ratio of the dispersed phase to the continuous phase is (40-70):30, further preferably (50-60):30; the high-speed shearing is performed at 5,000-15,000 rpm for 1-3 min; and a mass concentration of a nanoscale microgel in the continuous phase of the obtained double-emulsified W/O/W fat analogue is 0.2-2%.

The fourteenth purpose of the present disclosure is to provide 4D printed chocolate prepared by the method of the present disclosure.

### Beneficial Effects

(1) In the present disclosure, edible oil is structuralized by way of a synergistic effect of pea protein, mung bean protein and/or pea-edible gum or a mung bean-edible gum nanoscale dispersion solution, preparation conditions are simple and rapid, and harmful reagents and chemical components are not involved, so that green and safe effects are achieved, and practical use of a structuralized fat substitute in the field of food is expanded.

(2) In the present disclosure, vegetable protein, such as pea protein and mung bean protein, with poor gel properties is subjected to property improvement by physical and chemical means to obtain microgel particles with excellent properties, and a relatively high oil phase system is successfully stabilized, so that the applicable field of a fat substitute constructed based on the vegetable protein is greatly expanded.

(3) The healthy fat substitute prepared by the present disclosure has low contents of saturated fatty acids, no trans-fatty acids and good plasticity, can be used in aerated food and has the characteristics of low fat, nutrition and no burden, which is in line with a health trend.

(4) The structuralized fat substitute prepared by the present disclosure has properties of solids and semi-solids and can be used in decoration.

(5) The pea protein and the mung bean protein used in the present disclosure have various biological activities, which can meet nutritional and healthy dietary needs.

(6) The fat substitute prepared by the present disclosure has low contents of saturated fatty acids and no trans-fatty acids, and droplets have a particle size of 200 nm or below and a potential of −36 mV or below. The fat substitute can be stably stored for 30 days or above at room temperature, has excellent decorating properties and can be used as an excellent substitute for conventional baking fat.

(7) In the present disclosure, liquid edible vegetable oil is structuralized by way of a synergistic effect of vegetable protein and/or a vegetable protein-polysaccharide nanoscale dispersion solution, a W/O/W fat analogue system is obtained by double emulsification, preparation conditions are simple and rapid, and harmful reagents and chemical components are not involved, so that green and safe effects are achieved, a more stable structuralized vegetable oil system is obtained at a lower oil phase proportion, construction of low-fat and low-saturation fatty acid products is promoted conveniently, and practical use of the structuralized fat substitute in the field of food is expanded.

(8) In the present disclosure, a low-fat and low-saturation structuralized vegetable oil system is constructed by using the W/O/W system, which has a stable structure and can be used in 3D printing, so that construction of a customized system with certain structural strength and self-supporting properties is realized, and practical use of 3D printed products of structuralized vegetable oil with a medium or high internal phase in the field of food is promoted conveniently.

(9) The W/O/W healthy fat substitute prepared by the present disclosure has low contents of saturated fatty acids, no trans-fatty acids and good plasticity, can be used in aerated food and has the characteristics of low fat, nutrition and no burden, which is in line with a health trend of vegetable-based food.

(10) The double-emulsified W/O/W fat analogue prepared by the present disclosure can be used as a substitute for cocoa butter in conventional chocolate. By substituting the cocoa butter, water-containing chocolate is constructed, contents of fat and saturated fatty acids in the chocolate are effectively reduced, and needs of nutrition and health can be met, so that the use range of structuralized vegetable oil in the field of healthy low-fat food is greatly expanded.

(11) Since the structuralized W/O/W fat analogue prepared by the present disclosure is served as a substitute for cocoa butter, a cocoa butter equivalent or a cocoa butter substitute in conventional chocolate, contents of fat and saturated fatty acids in the conventional chocolate are effectively reduced. Meanwhile, by combining with a dual-channel 4D food printing technology, construction of multi-layer and multi-structure low-fat chocolate is realized, and the practical value of structuralized fat products in the field of food is increased.

(12) In the present disclosure, most stable structuralized oil is obtained by adjusting different proportions of a dispersed phase of liquid vegetable oil. Meanwhile, different gradient controls for the substitute proportion of the cocoa butter, the cocoa butter equivalent or the cocoa butter substitute by the structuralized oil in the chocolate system are made, and products with similar physical properties to conventional chocolate but different thermodynamic properties are selected, which can be used in development of 4D food printing.

(13) In the present disclosure, a class of multi-layer and multi-structure printed products are constructed by using two different materials in combination with advantages of a dual-channel printer, so that an interlaced effect of the two materials at a same level can be achieved, and spontaneous structural changes, namely 4D printing, under certain thermal induction conditions are achieved by using differences of the thermodynamic properties.

### BRIEF DESCRIPTION OF FIGURES

FIG. 1 shows droplet size distribution of gelatinized fat substitutes prepared in Examples 1-5 and Comparative Examples 1-4.

FIG. 2 shows optical microscope images of structuralized fats of the gelatinized fat substitutes prepared in Examples 1-5 and Comparative Examples 1-4.

FIG. 3 shows laser confocal microscope images of the gelatinized fat substitutes prepared in Examples 1-5 and Comparative Examples 1-4.

FIG. 4A-4B shows rheological properties of the gelatinized fat substitutes prepared in Examples 1-4, where FIG. 4A shows stress scanning, and FIG. 4B shows frequency scanning.

FIG. 5A-5D shows three-phase contact angles of the gelatinized fat substitutes prepared in Examples 1-4, where FIG. 5A shows Example 3, FIG. 5B shows Example 4, FIG. 5C shows Example 1, and FIG. 5D shows Example 2.

FIG. 6 shows macroscopic images of fat substitutes prepared in Examples 1 and 6 at different storage times, where soybean oil accounts for, from left to right, 10%, 20%, 30%, 40%, 50%, 60%, 70%, 80% and 90% of a mass of a nanoscale microgel solution in the obtained fat substitutes, respectively.

FIG. 7 shows rheological properties of stable fat substitutes obtained after compounding of mung bean protein and various kinds of edible gum in Examples 2, 4 and 7.

FIG. 8A-8C shows comparison of decorating properties of thin cream (FIG. 8A), a fat substitute constructed based on pea protein in Example 1 (FIG. 8B) and butter (FIG. 8C).

FIG. 9A-9B shows an optical microscope image (FIG. 9A) and a confocal microscope image (FIG. 9B) of W/O/W fat analogue prepared in Example 9.

FIG. 10A-10B shows rheological properties (FIG. 10A) and hardness (FIG. 10B) of the W/O/W fat analogue prepared in Example 9 and an O/W system prepared in Comparative Example 6.

FIG. 11A-11B shows 3D printed quadrilateral prism structures of W/O/W fat analogue (FIG. 11A) prepared in Example 10 and an O/W system (FIG. 11B) prepared in Comparative Example 7.

FIG. 12 shows 3D printed structure images of the W/O/W fat analogue prepared in Example 10 used in various models.

FIG. 13 shows 3D printed quadrilateral prism structures of W/O/W fat analogue prepared after substituting cocoa butter to different degrees in Examples 11-14 (from left to right, a cocoa butter substitute proportion is 25%, 50%, 75% and 100%, respectively).

FIG. 14A-14B shows a stress scanning diagram (FIG. 14A) and a frequency scanning diagram (FIG. 14B) in Examples 11-14.

FIG. 15 shows low-fat water-containing chocolate constructed by 3D printing using W/O/W fat analogue co-stabilized by a pea protein isolate microgel and xanthan gum particles prepared in Example 16 to substitute cocoa butter.

FIG. 16 shows 3D printed low-fat dark chocolate products constructed by substituting cocoa butter with structuralized oil constructed at different proportions of liquid vegetable oil in Example 18, where from left to right, an oil phase proportion is 36%, 45%, 54% and 63%, respectively.

FIG. 17 shows a multi-layer and multi-structure Tai Ji image and a low-fat chocolate model of a school badge of Jiangnan University obtained by using a dual-channel printer when the oil phase proportion in Example 18 is 54%.

FIG. 18 shows 3D printed low-fat dark chocolate products constructed by substituting cocoa butter with structuralized oil, namely a fat analogue system, at different proportions in Example 19, where from left to right, a cocoa butter substitute proportion is 0%, 25%, 50%, 75% and 100%, respectively.

FIG. 19 shows analysis of thermodynamic properties of different 3D printed chocolates constructed at different cocoa butter substitute proportions by using DSC in Example 19.

FIG. 20A-20B shows a printing mechanism diagram (FIG. 20A) and rheological property changes (FIG. 20B) when the cocoa butter substitute proportion is 0% and 100% in Example 19.

FIG. 21A-21C shows surface atomic force scanning microscope images when the cocoa butter substitute proportion is 0% (FIG. 21A), 50% (FIG. 21B) and 100% (FIG. 21C) in Example 19, where Ra represents average surface roughness of chocolate, and a higher value indicates a rougher surface.

FIG. 22 shows a change process of modeling, slicing, printing and 4D printing for preparing two types of chocolate with different melting points in Example 20, where the inner dark chocolate with a high melting point is heart-shaped, and the outer black (white) chocolate with a low melting point is cuboid.

FIG. 23 shows spontaneous structural changes of low-fat dark chocolate, namely 4D printing of chocolate, with a cocoa butter substitute proportion of 50% in an environment at 35° C. within 60 s in Example 20.

FIG. 24 shows multi-layer and multi-structure low-fat chocolate models of a Tai Ji image and a school badge of Jiangnan University obtained by using a dual-channel printer in Comparative Example 8.

FIG. 25 shows a five-pointed star model and a square box structure model printed at 35° C. in Comparative Example 9.

### DETAILED DESCRIPTION

Preferred examples of the present disclosure are described below. It is understood that the examples are intended to better explain the present disclosure, rather than to limit the present disclosure.

Test methods are as follows:

Test of droplet size distribution includes: diluting a fat substitute to 0.05 wt % with deionized water, and determining the particle size distribution of emulsion droplets with a particle size analyzer (S3500, Microtrac, USA).

Test of rheological properties of fat analogue includes: determining a linear viscoelastic region (LVR) by strain scanning in a strain amplitude range of 0.1-100 Pa; and carrying out a frequency scanning test in a frequency range of 0.01-100 Hz and a strain value of 1 Pa. In addition, all tests are carried out by using an aluminum sheet (with a diameter of 40 mm) with a gap value set as 1,000 μm.

Test of a three-phase contact angle includes: determining a contact angle of microgel particles at an oil-water interface and the ability to reduce the tension of the oil-water interface based on an optical contact angle of food. Surface properties of the microgel particles are determined under different ionic strength conditions in an experiment, respectively. A method for determining the contact angle includes: subjecting a solution to freeze-drying treatment to obtain a powder of microgel particles, and performing powder tableting to obtain a microgel wafer with a diameter of 1 cm; then completely soaking the wafer in soybean oil, and dropping about 2 μL of deionized water to the center of the microgel wafer through an injector with a diameter of 0.75 mm; and finally, capturing the contact angle by a high-speed camera of an instrument, and performing calculation.

Test of the hardness of chocolate includes: placing rectangular chocolate at 20° C. and 32° C. for stabilization for 12 h, respectively, cutting the chocolate with a blade probe, and determining the hardness. Test conditions are as follows: a height of a blade is 15 mm from an upper surface of a sample, a pre-test rate is 10 mm/s, a test rate is 0.5 mm/s, a return rate is 10 mm/s, and a compression distance is 50%.

Test of melting behaviors of chocolate includes: taking a differential scanning calorimeter (DSC), weighing about 5 mg of a chocolate sample in an aluminum box, setting heating and cooling procedures, and obtaining a melting curve, an initial melting temperature, a maximum temperature, an enthalpy value and the like.

Test of a melting crystallization curve includes: taking an indium and n-octadecane calibration instrument first, then weighing 5-8 mg of a sample in an aluminum box, and setting a sample temperature determination procedure: lowering the temperature from room temperature to −10° C. at 10° C./min, maintaining the temperature for 5 min to enable complete crystallization of the sample, then raising the temperature to 50° C. at 10° C./min, and maintaining the temperature for 5 min to obtain a melting curve. Then, an initial temperature, a maximum temperature, a final temperature and an enthalpy value (ΔH) of a melting peak are obtained by DSC software.

Test of rheological properties of chocolate includes: determining a linear viscoelastic region (LVR) by strain scanning in a strain amplitude range of 0.1-100 Pa. In determination of a strain recovery force, a strain force is 0.1 pa at 0-120 s, 100 pa at 120-240 s and 0.1 pa at 240-360 s. In addition, all tests are carried out by using an aluminum sheet (with a diameter of 40 mm) with a gap value set as 1,000 μm.

### Example 1

A method for preparing a healthy fat substitute only based on nanoscale pea protein isolate includes the following steps:
(1) preparing a pea protein isolate solution with a mass concentration of 15% by using a phosphate buffer as a solvent, performing full stirring with a stirrer at 300 rpm for 2 h, adjusting the pH value to 7.0, and placing the solution in a refrigerator for refrigeration at 4° C. for 12 h to enable full hydration of protein so as to obtain a hydrated pea protein isolate solution;
(2) subjecting the hydrated pea protein isolate solution obtained in step (1) to high-speed shearing (treated at 10,000 rpm for 2 min) and high pressure homogenization (treated at 100 MPa for 3 min) to obtain a nanoscale pea protein isolate dispersion solution;
(3) heating the nanoscale protein isolate dispersion solution in step (2) in a water bath pot at 80° C. for 20 min, and then performing cooling to 40° C. to obtain a modified pea protein isolate dispersion solution;
(4) adding 15 U/g of transglutaminase (TGase) into the pea protein isolate dispersion solution in step (3), adjusting the pH value to 7, performing enzymatic crosslinking in a water bath pot at 40° C. for 2 h, and finally performing heating in a water bath pot at 90° C. for 50 min to obtain a pea protein isolate gel;
(5) adding 2 times a mass of a phosphate buffer into the protein isolate gel in step (4), and performing microfluidization (treated at 40 MPa for 2 min) and high pressure homogenization (treated at 80 MPa for 1 min) to obtain a nanoscale microgel solution; and
(6) adding a nanogel particle dispersion solution obtained in step (5) into soybean oil, and performing high-speed shearing treatment (treated at 10,000 rpm for 2 min) to obtain a gelatinized fat substitute (abbreviated as: 1% of peas), where the soybean oil accounts for 50% of a mass of the nanoscale microgel solution, and a mass concentration of the pea protein in the whole system is 1%.

### Example 2

A method for preparing a healthy fat substitute only based on nanoscale mung bean protein isolate includes the following steps:

(1) preparing a mung bean protein isolate solution with a mass concentration of 15% by using a phosphate buffer as a solvent, performing full stirring with a stirrer at 300 rpm for 2 h, adjusting the pH value to 7.0, and placing the solution in a refrigerator for refrigeration at 4° C. for 12 h to enable full hydration of protein so as to obtain a hydrated mung bean protein isolate solution;

(2) subjecting the hydrated mung bean protein isolate solution obtained in step (1) to high-speed shearing (treated at 10,000 rpm for 2 min) and high-pressure homogenization (treated at 100 MPa for 3 min) to obtain a nanoscale mung bean protein isolate dispersion solution;

(3) heating the nanoscale protein isolate dispersion solution in step (2) in a water bath pot at 80° C. for 20 min, and then performing cooling to 40° C. to obtain a modified mung bean protein isolate dispersion solution;

(4) adding 15 U/g of transglutaminase (TGase) into the mung bean protein isolate dispersion solution in step (3), adjusting the pH value to 7, performing enzymatic crosslinking in a water bath pot at 40° C. for 2 h, and finally performing heating in a water bath pot at 90° C. for 50 min to obtain a mung bean protein isolate gel;

(5) adding 2 times a mass of a phosphate buffer into the mung bean protein isolate gel in step (4), and performing microfluidization (treated at 40 MPa for 2 min) and high-pressure homogenization (treated at 80 MPa for 1 min) to obtain a nanoscale microgel solution; and

(6) adding a mung bean nanogel particle dispersion solution obtained in step (5) into soybean oil, and performing high-speed shearing treatment (treated at 10,000 rpm for 2 min) to obtain a gelatinized fat substitute (abbreviated as: 1% of mung beans), where the soybean oil accounts for 50% of a mass of the nanoscale microgel solution, and a mass concentration of the mung bean protein in the whole system is 1%.

### Example 3

A method for preparing a healthy fat substitute based on compounding of nanoscale pea protein isolate and xanthan gum (XG) includes the following steps:
(1) preparing a pea protein isolate solution with a mass concentration of 15% by using a phosphate buffer as a solvent, performing full stirring with a stirrer at 300 rpm for 2 h, adjusting the pH value to 7.0, and placing the solution in a refrigerator for refrigeration at 4° C. for 12 h to enable full hydration of protein so as to obtain a hydrated pea protein isolate solution;
(2) subjecting the hydrated pea protein isolate solution obtained in step (1) to high-speed shearing (treated at 10,000 rpm for 2 min) and high-pressure homogenization (treated at 100 MPa for 3 min) to obtain a nanoscale pea protein isolate dispersion solution;
(3) heating the nanoscale protein isolate dispersion solution in step (2) in a water bath pot at 80° C. for 20 min, and then performing cooling to 40° C. to obtain a modified pea protein isolate dispersion solution;
(4) adding 15 U/g of transglutaminase (TGase) into the pea protein isolate dispersion solution in step (3), adjusting the pH value to 7, performing enzymatic crosslinking in a water bath pot at 40° C. for 2 h, and finally performing heating in a water bath pot at 90° C. for 50 min to obtain a pea protein isolate gel;
(5) adding 2 times a mass of a phosphate buffer into the protein isolate gel in step (4), and performing microfluidization (treated at 40 MPa for 2 min) and high pressure homogenization (treated at 80 MPa for 1 min) to obtain a nanoscale microgel solution;
(6) preparing a xanthan gum solution with a mass concentration of 1%;
(7) mixing a gelatinized nanogel dispersion solution obtained in step (5) with the xanthan gum solution obtained in step (6) at a volume ratio of 1:1 to form a mixed solution; adding 2 times a mass (relative to the mixed solution) of a phosphate buffer for dilution, and performing shearing treatment (treated at 5,000 rpm for 1 min) to obtain a preliminary mixing system of pea nanogel particles and xanthan gum; and then treating the preliminary mixing system of nanogel particles and xanthan gum by high pressure homogenization (treated at 80 MPa for 2 min) to obtain a nanogel particle-xanthan gum dispersion system;
(8) adding the nanogel particle-xanthan gum dispersion system obtained in step (7) into soybean oil, and performing high-speed shearing treatment (treated at 10,000 rpm for 2 min) to obtain a gelatinized fat substitute (abbreviated as: 1% of peas+0.1% of XG), where the soybean oil accounts for 50% of a mass of the nanogel particle-xanthan gum dispersion system, and a mass concentration of the pea protein in the whole system is 1%.

### Example 4

A method for preparing a healthy fat substitute based on compounding of nanoscale mung bean protein isolate and xanthan gum (XG) includes the following steps:
(1) preparing a mung bean protein isolate solution with a mass concentration of 15% by using a phosphate buffer as a solvent, performing full stirring with a stirrer at 300 rpm for 2 h, adjusting the pH value to 7.0, and placing the solution in a refrigerator for refrigeration at 4° C. for 12 h to enable full hydration of protein so as to obtain a hydrated mung bean protein isolate solution;
(2) subjecting the hydrated mung bean protein isolate solution obtained in step (1) to high-speed shearing (treated at 10,000 rpm for 2 min) and high pressure homogenization (treated at 100 MPa for 3 min) to obtain a nanoscale mung bean protein isolate dispersion solution;
(3) heating the nanoscale protein isolate dispersion solution in step (2) in a water bath pot at 80° C. for 20 min, and then performing cooling to 40° C. to obtain a modified mung bean protein isolate dispersion solution;
(4) adding 15 U/g of transglutaminase (TGase) into the mung bean protein isolate dispersion solution in step (3), adjusting the pH value to 7, performing enzymatic crosslinking in a water bath pot at 40° C. for 2 h, and finally performing heating in a water bath pot at 90° C. for 50 min to obtain a mung bean protein isolate gel;
(5) adding 2 times a mass of a phosphate buffer into the mung bean protein isolate gel in step (4), and performing microfluidization (treated at 40 MPa for 2 min) and high pressure homogenization (treated at 80 MPa for 1 min) to obtain a nanoscale microgel solution; and
(6) preparing a xanthan gum solution with a mass concentration of 1%;
(7) mixing a gelatinized nanogel dispersion solution obtained in step (5) with the xanthan gum solution obtained in step (6) at a volume ratio of 1:1 to form a mixed solution; adding 2 times a mass (relative to the mixed solution) of a phosphate buffer for dilution, and performing shearing treatment (treated at 5,000 rpm for 1 min) to obtain a preliminary mixing system of mung bean nanogel particles and xanthan gum; and then treating the preliminary mixing system of nanogel particles and xanthan gum by high pressure homogenization (treated at 80 Mpa for 2 min) to obtain a mung bean nanogel particle-xanthan gum dispersion system; and
(8) adding the mung bean nanogel particle-xanthan gum dispersion system obtained in step (7) into soybean oil, and performing high-speed shearing treatment (treated at 10,000 rpm for 2 min) to obtain a gelatinized fat substitute (abbreviated as: 1% of mung beans+0.1% of XG), where the soybean oil accounts for 50% of a mass of the nanogel particle-xanthan gum dispersion system, and a mass concentration of the mung bean protein in the whole system is 1%.

### Example 5

The phosphate buffer added in all steps was changed into deionized water, other conditions were consistent with those in Example 3, and a gelatinized fat substitute was obtained.

### Comparative Example 1

The step (2) in Example 3 was omitted, other conditions were consistent with those in Example 3, and a gelatinized fat substitute was obtained.

### Comparative Example 2

The microfluidization treatment in step (5) in Example 3 was omitted, other conditions were consistent with those in Example 3, and a gelatinized fat substitute was obtained.

### Comparative Example 3

The high-pressure homogenization treatment after addition of the xanthan gum solution in step (7) was omitted, other conditions were consistent with those in Example 3, and a gelatinized fat substitute was obtained.

### Comparative Example 4

Peanut protein in Example 1 of a patent CN107455550A was substituted with pea protein, and preparation includes the following steps:

(1) preparing a 6% pea protein isolate solution, performing stirring for 2 h, and placing the solution at 4° C. for refrigeration overnight to obtain a pea protein dispersion solution;

(2) adjusting the pH value of the pea protein dispersion solution to 6.3, heating the solution at 70° C. for 14 min, performing cooling to room temperature, then adding (7 U/g of pea protein isolate) transglutaminase to carry out a crosslinking reaction in a water bath at 37° C. for 1 h, and after the reaction is completed, performing heating at 85° C. for 10 min to obtain a gel block;

(3) adding two times a mass of water into the gel block obtained in step (2), performing treatment with a high-speed disperser at 8,500 rpm for 35 s to obtain a coarse microgel particle dispersion solution, and then performing high pressure homogenization at 750 bar for 2 min to obtain a microgel particle dispersion solution;

(4) adding the dispersion solution obtained in step (3) into soybean oil, where particles have a concentration of 0.5%, and an oil phase has a mass fraction of 50%; and performing treatment at 8,500 rpm for 60 s to obtain a pea protein emulsion system.

### Comparative Example 5

The xanthan gum solution in step (6) and the pea protein isolate solution in step (1) were mixed at 100:1, addition of the xanthan gum solution in step (7) was omitted, other conditions were consistent with those in Example 3, and a gelatinized fat substitute was obtained.

Compared with Example 3, the gelatinized fat substitute obtained in Comparative Example 5 lacks certain fat properties and has a poor gelatinization effect, which may be caused by uneven distribution of xanthan gum after addition in the system.

Properties of the obtained fat substitutes were tested, and test results are as follows.

TABLE 1
Test results in Examples 1-5 and Comparative Examples 1-4

| Example | ζ potential (mV) | Particle size (nm) |
|---|---|---|
| Example 1 | −38.21 | 196.54 |
| Example 2 | −39.65 | 178.26 |
| Example 3 | −37.52 | 192.46 |
| Example 4 | −36.94 | 170.62 |
| Example 5 | −34.59 | 224.78 |
| Comparative | −32.56 | 475.32 |
| Example 1 | | |
| Comparative | −33.61 | 721.39 |
| Example 2 | | |
| Comparative | −31.25 | 236.17 |
| Example 3 | | |
| Comparative | −33.32 | 234.41 |
| Example 4 | | |

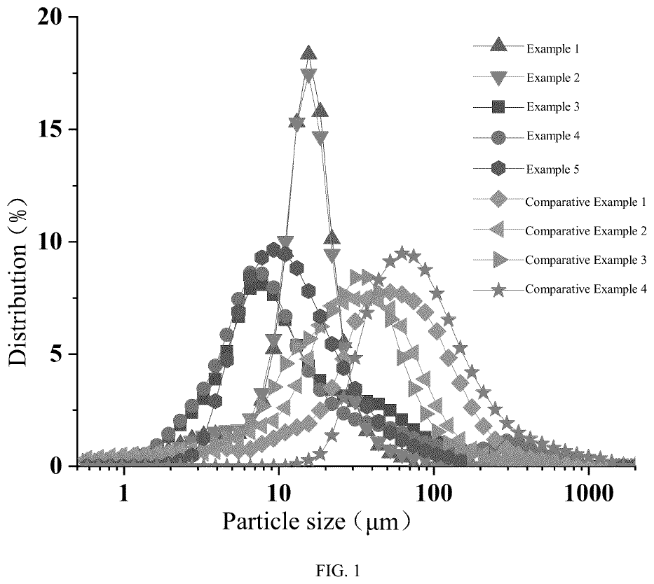

FIG. 1 shows droplet size distribution of the gelatinized at substitutes prepared in Examples 1-5 and Comparative Examples 1-4. As can be seen from FIG. 1, Examples 3 and 4 have optimal effects, the particle size distribution of emulsion droplets is most concentrated and is concentrated in the range of 10-20 μm, and the stable gelatinized fat substitutes are formed more easily. That is to say, the gelatinized fat substitutes stabilized by protein and xanthan gum have better particle size distribution, while the systems stabilized only by protein also have good particle size distribution, but the distribution is relatively dispersed.

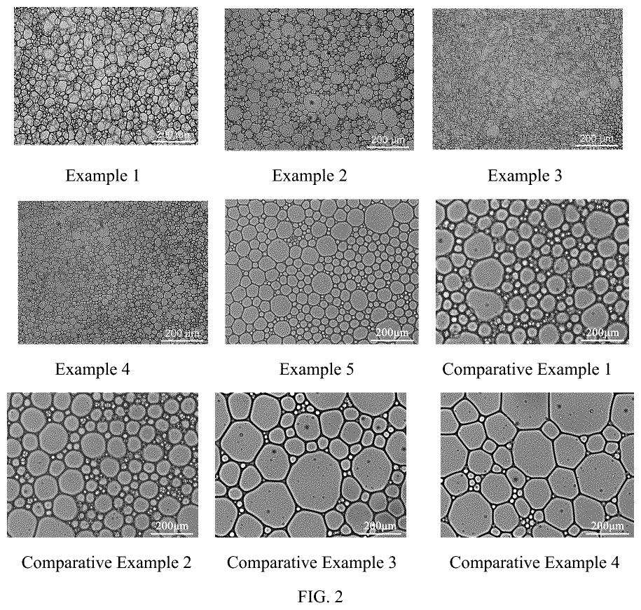

FIG. 2 shows optical microscope images of structuralized fats of the gelatinized fat substitutes prepared in Examples 1-5 and Comparative Examples 1-4. As can be seen from FIG. 2, the gelatinized fat substitutes co-stabilized by protein and xanthan gum in Examples 3 and 4 have optimal microstructures.

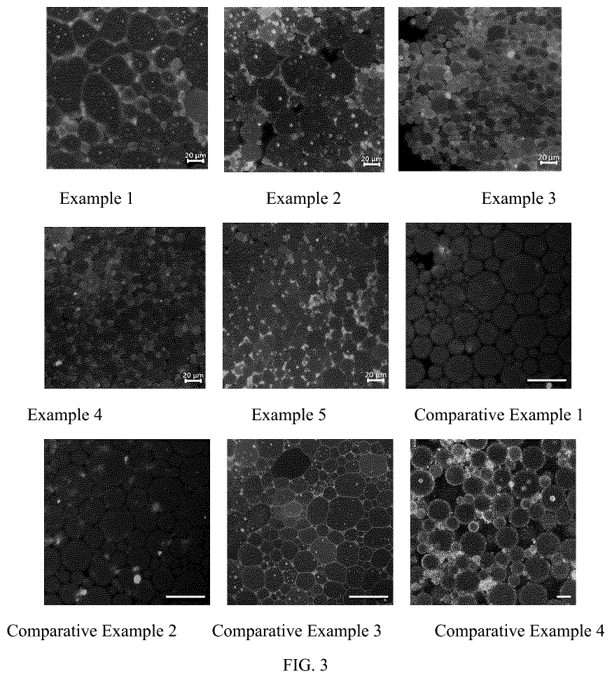

FIG. 3 shows laser confocal microscope images of the gelatinized fat substitutes prepared in Examples 1-5 and Comparative Examples 1-4. As can be seen from FIG. 3, the distribution of an oil phase, protein and xanthan gum in a system can be directly analyzed by laser confocal microscopy, where oil droplets are wrapped by a water phase, a layer of dense membrane structure constructed by protein and/or xanthan gum is formed at an oil-water interface, and the layer of membrane structure is the main reason for the stability of the gelatinized fat substitutes. Due to a thickening effect of emulsification of the xanthan gum, most stable systems are obtained in Examples 3 and 4.

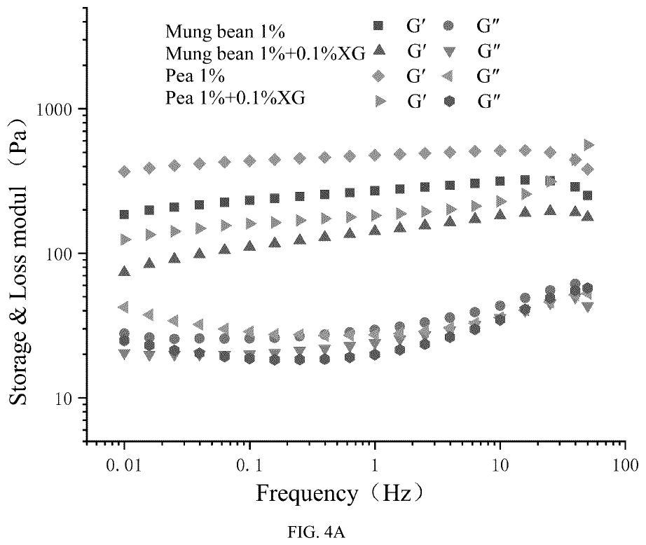

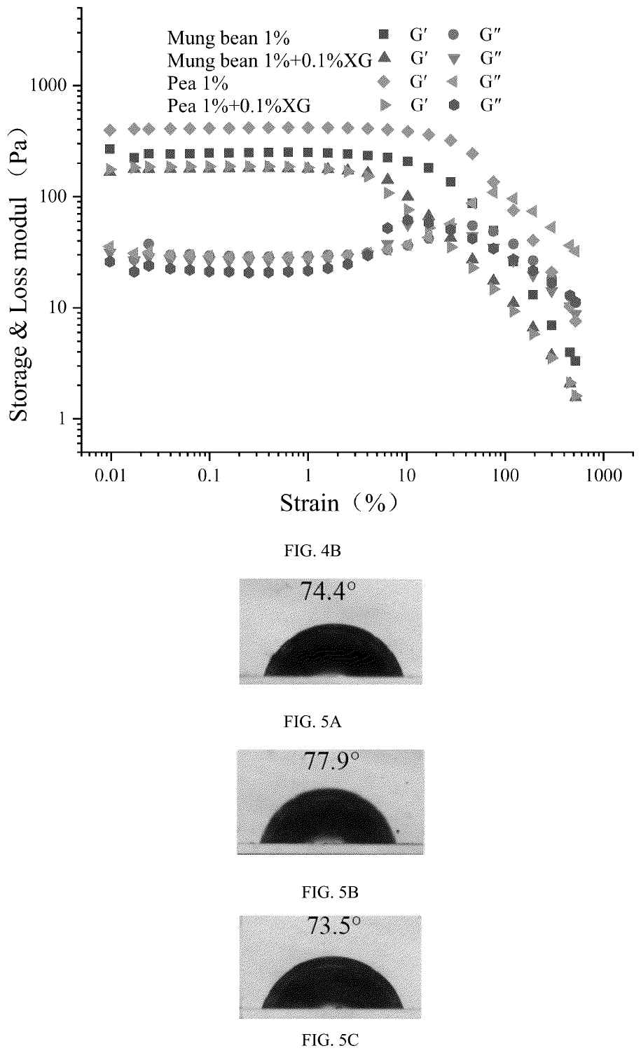

FIG. 4A-4B shows rheological properties of the gelatinized fat substitutes prepared in Examples 1-4, where FIG. 4A shows stress scanning, and FIG. 4B shows frequency scanning. Strength changes under the action of a certain shear force in different examples can be judged by stress scanning and frequency scanning. As can be seen from FIG. 4A-4B, differences between Examples 1 and 4 are not obvious, the storage modulus is greater than the loss modulus in an entire shearing process, and that is to say, solid properties are shown in the whole process.

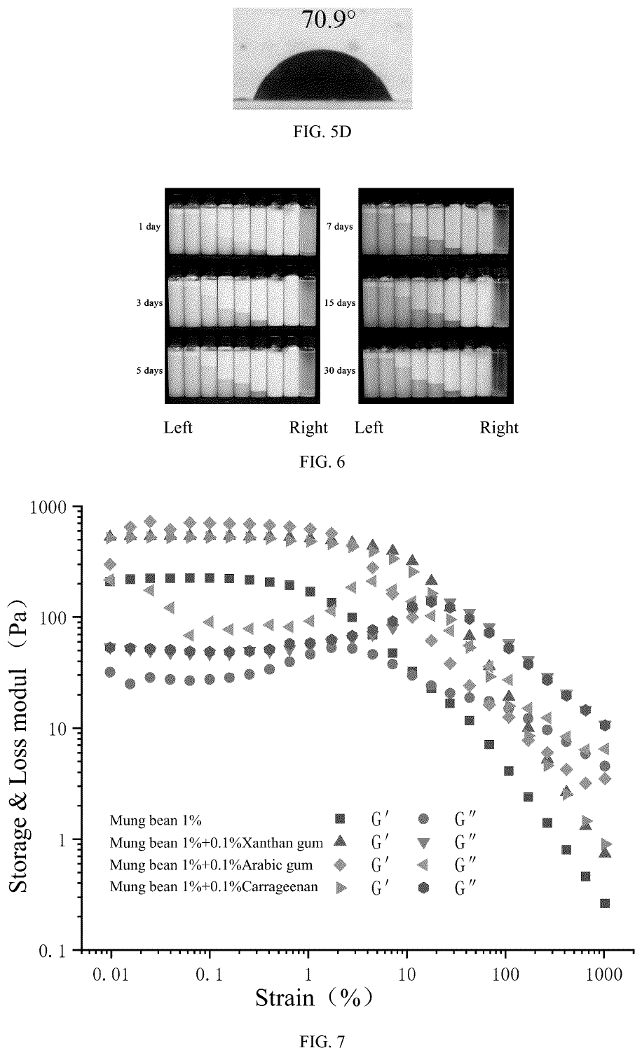

FIG. 5A-5D shows three-phase contact angles of the gelatinized fat substitutes prepared in Examples 1-4, where FIG. 5A shows Example 3, FIG. 5B shows Example 4, FIG. 5C shows Example 1, and FIG. 5D shows Example 2. As can be seen from FIG. 5A-5D, all the three-phase contact angles in Examples 1-4 are in an optimal range, particles have the effect of stabilizing an oil-water interface in this case, and the stable gelatinized fat substitutes can be formed.

### Example 6

The mass percentage of the soybean oil in the nanoscale microgel solution in Example 1 was adjusted to 10%, 20%, 30%, 40%, 50%, 60%, 70%, 80% and 90%, other conditions were consistent with those in Example 1, and pea protein fat substitutes were obtained.

The obtained fat substitutes were tested, and test results are shown in FIG. 6.

FIG. 6 shows macroscopic images of the fat substitutes prepared in Examples 1 and 6 at different storage times. As can be seen from FIG. 6, when the volume of an oil phase (soybean oil) is low, the fat substitutes have the phenomenon of water precipitation after long-term storage. However, when the proportion of the oil phase reaches 60% or above, layering is not observed, and the fat substitutes can be stably stored for more than one month. Meanwhile, when the proportion of the oil phase reaches 90%, phase inversion occurs, and systems of the gelatinized fat substitutes are not stable any more.

### Example 7

The xanthan gum in Example 4 was adjusted to Arabic gum and carrageenan, other conditions were consistent with those in Example 4, and gelatinized fat substitutes were obtained, abbreviated as: 1% of peas+0.1% of Arabic gum and 1% of peas+0.1% of carrageenan, respectively.

The obtained fat substitutes were tested, and test results are shown in FIG. 7.

FIG. 7 shows rheological properties of stable fat substitutes obtained after compounding of mung bean protein and various kinds of edible gum in Examples 2, 4 and 7. As can be seen from FIG. 7, the strength and shear resistance of the gelatinized fat substitutes can be improved to a certain extent after adding edible gum such as Arabic gum and carrageenan.

### Example 8 Use in Decoration

The pea protein fat substitute in Example 1 was stored at low temperature for 5 h, and 50 g of the fat substitute was filled into a decorating bag and treated with a fine tooth type decorating nozzle having a diameter of 5 mm to obtain a certain self-supporting structure.

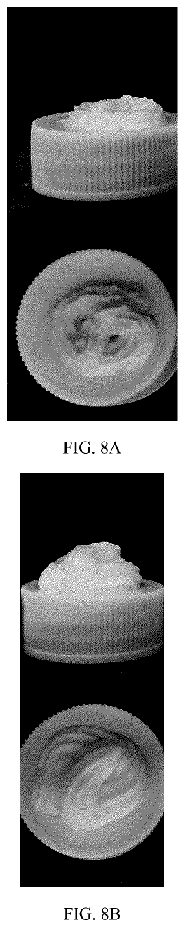

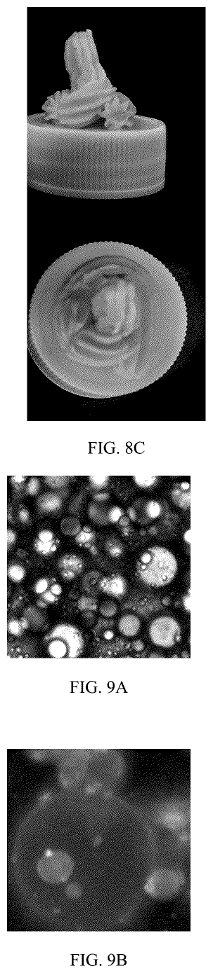

Specific results are shown in FIG. 8A-8C. As can be seen from FIG. 8A-8C, the gelatinized fat substitute stabilized only by pea protein has better decorating properties than thin cream, but still has a certain gap in strength compared with butter.

### Example 9

A method for preparing double-emulsified W/O/W fat analogue capable of being used in 3D printing based on nanoscale pea protein includes the following steps:
(1) preparing a pea protein isolate solution with a mass concentration of 10% by using a phosphate buffer as a solvent, performing full stirring at 300 rpm for 2 h, adjusting the pH value to 6.7, and placing the solution in a refrigerator for refrigeration at 4° C. for 12 h to obtain a pea protein isolate solution;
(2) subjecting the hydrated pea protein isolate solution obtained in step (1) to high-speed shearing (treated at 10,000 rpm for 2 min) and high pressure homogenization (treated at 100 MPa for 3 min) to obtain a nanoscale pea protein isolate dispersion solution;
(3) heating the nanoscale protein isolate dispersion solution in step (2) in a water bath pot at 80° C. for 20 min, and then performing cooling to 40° C. to obtain a modified pea protein isolate dispersion solution;
(4) adding 15 U/g of transglutaminase (TGase) into the pea protein isolate dispersion solution in step (3), adjusting the pH value to 7, performing enzymatic crosslinking in a water bath pot at 40° C. for 2 h, and finally performing heating in a water bath pot at 90° C. for 50 min to obtain a pea protein isolate gel;
(5) adding 2 times a mass of a phosphate buffer into the protein isolate gel in step (4), and performing high pressure homogenization (treated at 80 Mpa for 1 min) to obtain a nanoscale microgel solution;
(6) adding 20 mL of a nanogel particle dispersion solution obtained in step (5) into 80 mL of soybean oil, and performing high-speed shearing treatment (treated at 10,000 rpm for 2 min) to obtain a W/O emulsion system, where the soybean oil accounts for 80% of a mass of the nanoscale microgel solution, and a mass concentration of the pea protein in the whole system is 1%;
(7) mixing 70 mL of the W/O emulsion in step (6) with 30 mL of the nanoscale microgel particle dispersion solution in step (5), and performing high-speed shearing (treated at 8,000 rpm for 1 min) to obtain double-emulsified W/O/W fat analogue, where a proportion of an oil phase in the emulsion system is 56%.

The obtained double-emulsified W/O/W fat analogue was tested, and test results are as follows.

FIG. 9A-9B shows an optical microscope image and a confocal microscope image of the W/O/W fat analogue constructed in Example 9, where a dispersed phase in confocal microscopy is an oil phase, a continuous phase is distribution of nanoscale microgel particles, and a water-in-oil-in-water multiple system formed after double emulsification can be observed obviously. The formation of the double emulsion shows to a certain extent that a more stable emulsion system can be obtained at a lower oil phase content.

### Comparative Example 6

A preparation method for an O/W emulsion includes the following steps:
(1) preparing a pea protein isolate solution with a mass concentration of 10% by using a phosphate buffer/water as a solvent, performing full stirring at 300 rpm for 2 h, adjusting the pH value to 6.7, and placing the solution in a refrigerator for refrigeration at 4° C. for 12 h to obtain a pea protein isolate solution;
(2) subjecting the hydrated pea protein isolate solution obtained in step (1) to high-speed shearing (treated at 10,000 rpm for 2 min) and high pressure homogenization (treated at 100 MPa for 3 min) to obtain a nanoscale pea protein isolate dispersion solution;
(3) heating the nanoscale protein isolate dispersion solution in step (2) in a water bath pot at 80° C. for 20 min, and then performing cooling to 40° C. to obtain a modified pea protein isolate dispersion solution;
(4) adding 15 U/g of transglutaminase (TGase) into the pea protein isolate dispersion solution in step (3), adjusting the pH value to 7, performing enzymatic crosslinking in a water bath pot at 40° C. for 2 h, and finally performing heating in a water bath pot at 90° C. for 50 min to obtain a pea protein isolate gel;
(5) adding 2 times a mass of a phosphate buffer into the protein isolate gel in step (4), and performing microfluidization (treated at 40 MPa for 2 min) and high pressure homogenization (treated at 80 MPa for 1 min) to obtain a nanoscale microgel solution; and
(6) adding 44 mL of a nanogel particle dispersion solution obtained in step (5) into 56 mL of soybean oil, and performing high-speed shearing treatment (treated at 10,000 rpm for 2 min) to obtain an O/W emulsion by single emulsification, where the soybean oil accounts for 56% of the microgel solution.

The emulsions in Example 9 and Comparative Example 6 were tested, and test results are as follows.

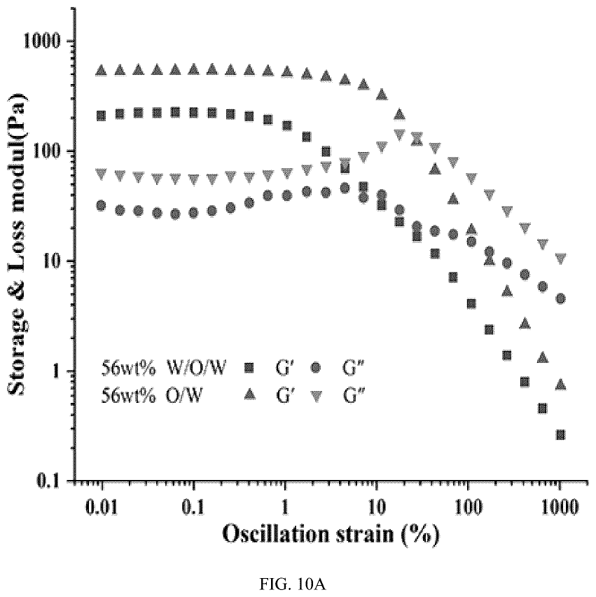

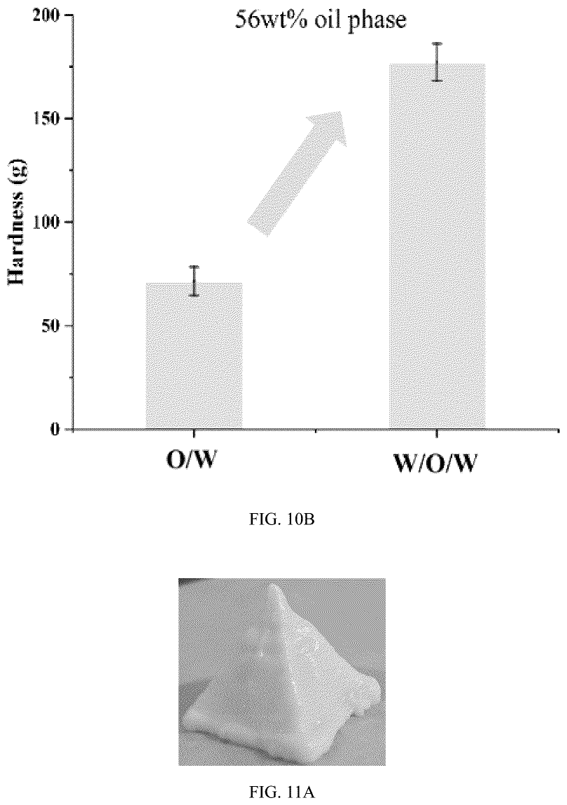

FIG. 10A-10B shows strain scanning properties and hardness differences of the W/O/W fat analogue system prepared in Example 9 and the O/W system prepared in Comparative Example 6. As can be seen from FIG. 10A-10B, under the premise that the proportions of oil phases in the systems are the same and are 56%, the W/O/W fat analogue formed by double emulsification has greater elastic modulus and a wider linear viscoelastic region, and the hardness of the system is also greatly improved as determined by a texture analyzer, so that the system is more suitable for 3D printing.

### Example 10

Use of the double-emulsified W/O/W fat analogue in Example 9 in 3D printing includes the following steps:
(1) filling the double-emulsified W/O/W system having an oil phase proportion of 56% obtained in Example 9 into a 3D printing needle tube with a capacity of 100 mL to ensure that the system in the needle tube is uniform and not dispersed;
(2) adjusting the temperature in a printing chamber to 25° C., selecting a 3D printing gun head with a diameter of 0.4 mm for filling, and adjusting X, Y and Z axes of a 3D printer to zero by program setting;
(3) designing a printing model by using 3ds Max digital model software, generating several layers of corresponding three-dimensional slices by cura slicing software to obtain a slice model, calculating a path of each layer of slice by using programming G codes, and finally inputting the path to a printing device;
(4) setting various parameters in a 3D printing process, which are specifically as follows: a printing layer thickness is 0.2 mm, a wall thickness is 0.4 mm, a filling density is 20%, a bottom and top layer thickness is 0.2 mm, a printing rate is 80 mm/s, a printing temperature is 25° C., an initial layer thickness is 0.2 mm, an initial layer line width is 10%, a bottom layer cut thickness is 0 mm, a moving rate is 60 mm/s, a bottom layer rate is 60 mm/s, a filling rate is 60 mm/s, a bottom and top layer rate is 60 mm/s, a shell rate is 40 mm/s, and an inner wall rate is 80 mm/s;
(5) performing 3D printing by using the device according to the imported slice model in step (3) to form a customized model with certain self-supporting properties.

### Comparative Example 7

The W/O/W fat analogue emulsion having an oil phase proportion of 56% used in Example 10 was substituted with the O/W emulsion having an oil phase proportion of 56% prepared in Comparative Example 6, other conditions were consistent with those in Example 10, and a 3D printed product was constructed.

The 3D printed products obtained in Example 10 and Comparative Example 7 were tested, and test results are as follows.

FIG. 11A-11B shows 3D printed systems prepared in Example 10 and Comparative Example 7. Mass proportions of oil phases in the two systems are controlled to be the same and are 56%, and models for printing structures are also the same. As can be observed, the W/O/W fat analogue formed by double emulsification forms a relatively stable structural model after 3D printing with an instrument, while the O/W system obtained by single emulsification only has a certain self-supporting shape and poor formability and cannot completely restore a structure constructed by a 3D printing model.

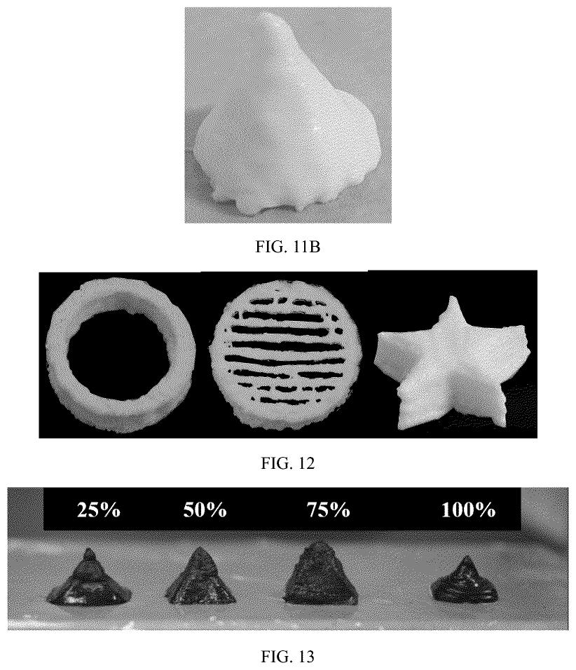

FIG. 12 shows customized 3D modeling products with different structures obtained in Example 10.

### Example 11

A method for preparing 3D printed chocolate by using the double-emulsified W/O/W fat analogue based on pea protein prepared in Example 9 to substitute cocoa butter includes the following steps:

(1) fully stirring 17.5 g of the W/O/W fat analogue emulsion obtained in Example 9 and 17.5 g of solid cocoa butter for dissolution in a water bath at 70° C. to obtain a cocoa butter solution substituted with 50% of an emulsion gel for later use;

(2) mixing the solution obtained in step (1) with 44.5 g of powdered sugar, 20 g of defatted cocoa powder and 0.5 g of soybean lecithin, mixing all the components in a ball mill, and performing fine grinding continuously at 600 rpm for 3 h to obtain a low-fat water-containing chocolate paste;

(3) filling the system obtained in step (2) into a 3D printing needle tube with a capacity of 100 mL to ensure that the system in the needle tube is uniform and not dispersed;

(4) adjusting the temperature in a printing chamber to 30° C., selecting a 3D printing gun head with a diameter of 1.2 mm for filling, and adjusting X, Y and Z axes of a 3D printer to zero by program setting;

(5) designing a regular quadrilateral prism with a bottom surface length and width of 4 cm and a height of 2.28 cm by using 3ds Max digital model software, generating several layers of corresponding three-dimensional slices by Cura slicing software to obtain a slice model, calculating a path of each layer of slice by using programming G codes, and finally inputting the path to a printing device;

(6) setting various parameters in a 3D printing process, which are specifically as follows: a printing layer thickness is 0.4 mm, a wall thickness is 1.2 mm, a filling density is 10%, a bottom and top layer thickness is 0.2 mm, a printing rate is 80 mm/s, a printing temperature is 30° C., an initial layer thickness is 0.2 mm, an initial layer line width is 10%, a bottom layer cut thickness is 0 mm, a moving rate is 60 mm/s, a bottom layer rate is 60 mm/s, a filling rate is 60 mm/s, a bottom and top layer rate is 60 mm/s, a shell rate is 40 mm/s, and an inner wall rate is 80 mm/s;

(7) performing 3D printing by using the device according to the imported slice model in step (5) to form a customized model with certain self-supporting properties, namely 3D printed chocolate.

### Example 12

The substitute proportion of the W/O/W fat analogue emulsion for the cocoa butter used in Example 11 was adjusted from 50% to 75%, other conditions were consistent with those in Example 11, and 3D printed chocolate was constructed.

### Example 13

The substitute proportion of the W/O/W fat analogue emulsion for the cocoa butter used in Example 11 was adjusted from 50% to 100%, other conditions were consistent with those in Example 11, and 3D printed chocolate was constructed.

### Example 14

The substitute proportion of the W/O/W fat analogue emulsion for the cocoa butter used in Example 11 was adjusted from 50% to 0%, other conditions were consistent with those in Example 11, and 3D printed chocolate (commercially available chocolate) was constructed.

The obtained 3D printed chocolate was tested, and test results are as follows.

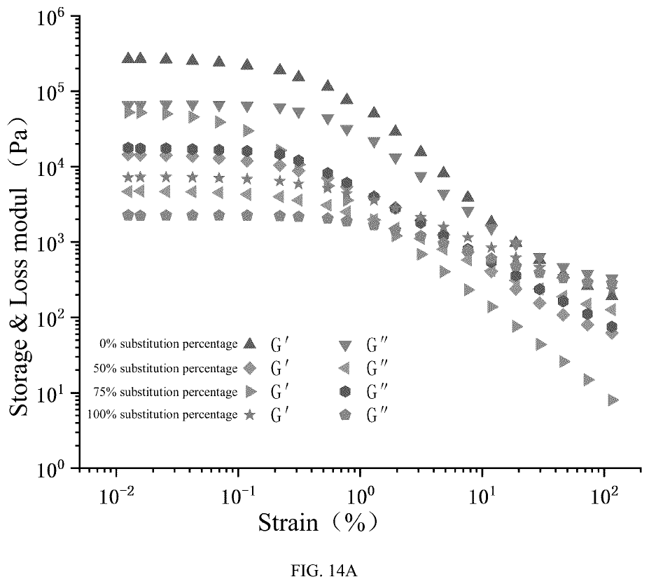

FIG. 13 shows 3D printed chocolate products with different cocoa butter substitute proportions printed and constructed in Examples 11-14. As can be observed, structural properties are relatively stable and uniform when the cocoa butter substitute proportion is 50% and 75%.

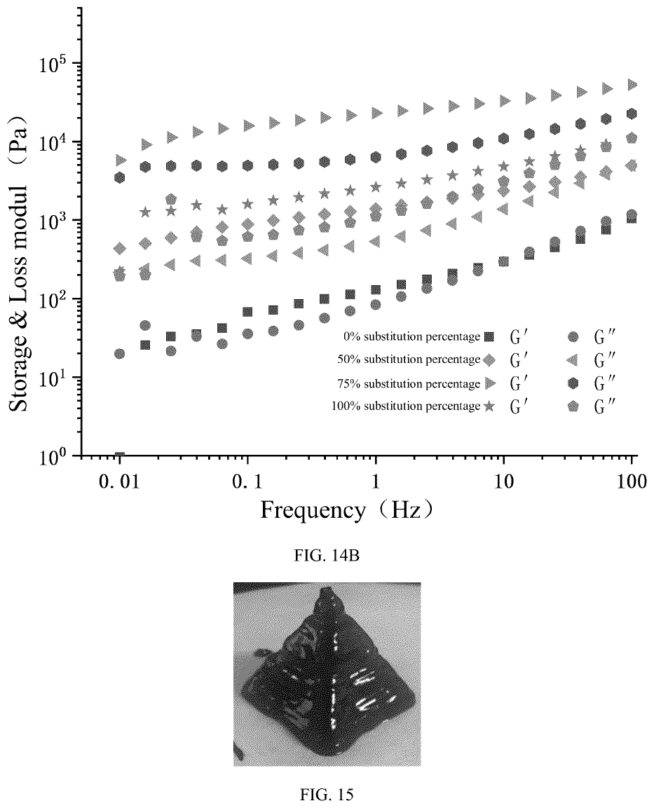

FIG. 14A-14B shows differences of rheological properties of chocolate models constructed in Examples 11-14, where a chocolate system constructed with pure cocoa butter in Example 13 has similar properties to commercially available chocolate. As can be observed from rheological properties, in chocolate pastes obtained at different substitute proportions, the chocolate paste obtained at a substitute proportion of 50% has most similar properties to commercially available chocolate.

Table 2 shows tests of hardness and melting characteristics of chocolates constructed in Examples 11-14. As can be seen from Table 2, the hardness (20° C.) of the chocolates in Examples 11, 12 and 13 is slightly reduced compared with that of the commercially available chocolate in Example 14, which is reduced in a certain trend with increase of the cocoa butter substitute proportion, but the overall strength has no great differences. Meanwhile, the commercially available chocolate in Example 14 is basically melted completely and has sharply reduced hardness at 32° C., and the hardness in Examples 11-13 is also greatly reduced. By combining with the melting characteristics in Examples 11-14, similar enthalpy changes in a similar temperature range are shown in Examples 11, 12 and 13, indicating that the melting characteristics of water-containing chocolate obtained after partially substituting the cocoa butter with W/O/W are not greatly different from that of conventional commercially available chocolate, and low-fat upgrade of products can be realized to a certain extent.

TABLE 2
Test results of hardness and melting characteristics of chocolate

| | | | | | Example 14 |
|---|---|---|---|---|---|
| | | | | | (Commercially |
| | | | | | available |
| Index | | Example 11 | Example 12 | Example 13 | chocolate) |
| Hardness (N) | 20° C. | 462.5 ± 61.3 | 432.3 ± 71.8 | 398.7 ± 49.1 | 512.6 ± 100.2 |
| | 32° C. | 22.1 ± 6.5 | 39.2 ± 4.4 | 59.7 ± 9.5 | 8.6 ± 0.1 |
| Melting | Initial | 29.6 ± 0.9 | 30.2 ± 1.1 | 30.9 ± 0.3 | 28.2 ± 0.5 |
| characteristics | temperature | | | | |
| | (° C.) | | | | |
| | Maximum | 36.2 ± 1.2 | 37.1 ± 0.9 | 38.3 ± 0.7 | 35.4 ± 0.5 |
| | temperature | | | | |
| | (° C.) | | | | |
| | Enthalpy | 48.6 ± 1.7 | 49.3 ± 2.8 | 49.5 ± 3.1 | 41.7 ± 4.2 |
| | change (J/g) | | | | |

### Example 15

A method for preparing double-emulsified W/O/W fat analogue capable of being used in 3D printing based on compounding of pea protein and xanthan gum includes the following steps:
steps (1)-(5): performing the same operations as those in steps (1)-(5) in Example 9;
(6) preparing a xanthan gum solution with a mass concentration of 0.5%;
(7) mixing a gelatinized microgel dispersion solution obtained in step (5) with the xanthan gum solution obtained in step (6), adding water for dilution, and performing treatment by a shearing machine at 10,000 rpm for 2 min to obtain a preliminary mixing system of protein microgel particles and xanthan gum; and further treating the mixing system of nanogel particles and xanthan gum by a high pressure homogenizer at 80 MPa to obtain a stable protein microgel particle-xanthan gum dispersion system;
(8) adding a protein-xanthan gum mixed solution obtained in step (7) into edible liquid vegetable oil, where the added protein has a mass concentration of 1%, and an oil phase has a mass fraction of 80%; and performing high-speed shearing treatment at 10,000 rpm for 1 min to obtain a W/O system;
(9) performing secondary emulsification by using 70 g of a W/O emulsion obtained in step (8) as a whole as a dispersed phase and 30 g of the gelatinized nanoscale microgel dispersion solution obtained in step (7) as a continuous phase, and performing high-speed shearing at 8,000 rpm for 90 s to obtain W/O/W fat analogue.

### Example 16

Use of the W/O/W fat analogue obtained in Example 15 in 3D printing includes the following steps:

(1) stirring 17.5 g of the W/O/W fat analogue, 17.5 g of cocoa butter, 0.5 g of soybean lecithin, 20 g of defatted cocoa powder and 45.5 g of powdered sugar for dissolution in a water bath, controlling the substitute proportion of the W/O/W fat analogue for the cocoa butter as 50%, and placing the components in a ball mill for continuous fine grinding at 600 rpm for 3 h to obtain a low-fat water-containing chocolate paste;

(2) placing 100 g of the chocolate paste in a 3D printing needle tube to ensure that the system in the needle tube is not layered;

(3) adjusting the temperature in a printing chamber to 30° C., selecting a 3D printing gun head with a diameter of 1.2 mm for filling, and adjusting X, Y and Z axes of a 3D printer to zero by program setting;

(4) designing a regular quadrilateral prism with a bottom surface length and width of 4 cm and a height of 2.28 cm by using 3ds Max digital model software, generating several layers of corresponding three-dimensional slices by Cura slicing software to obtain a slice model, calculating a path of each layer of slice by using programming G codes, and finally inputting the path to a printing device;

(5) setting various parameters in a 3D printing process, which are specifically as follows: a printing temperature is 32° C., a printing needle diameter is 1.2 mm, a printing layer thickness is 1.2 mm, a wall thickness is 1.2 mm, a filling density is 20%, a bottom and top layer thickness is 1.2 mm, a printing rate is 40 mm/s, an initial layer line width is 1.2 mm, a bottom layer cut thickness is 0 mm, a moving rate is 40 mm/s, a bottom layer rate is 20 mm/s, a filling rate is 80 mm/s, a bottom and top layer rate is 40 mm/s, a shell rate is 60 mm/s, and an inner wall rate is 50 mm/s;

(6) performing 3D printing by using the device according to the imported slice model in step (4) to form a customized model with certain self-supporting properties, namely 3D printed chocolate.

The obtained 3D printed chocolate was tested, and test results are as follows.

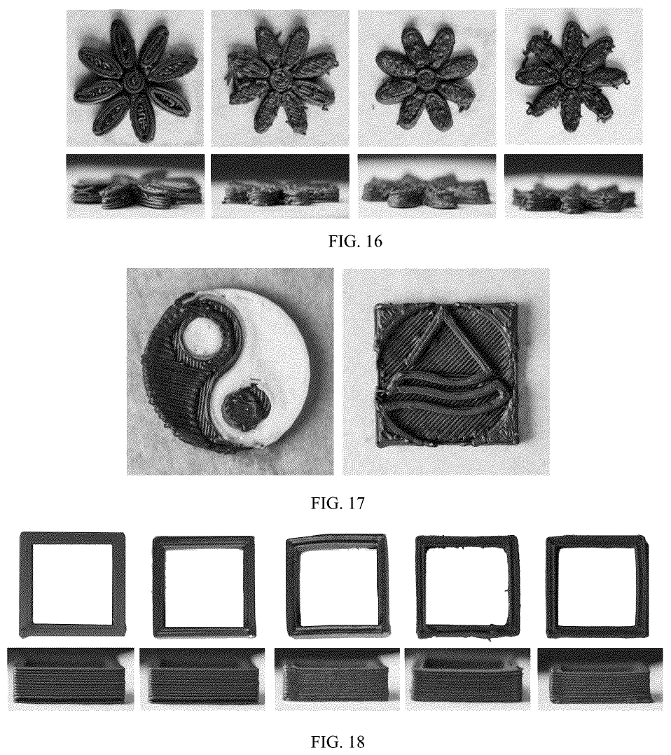

FIG. 15 shows a product further used for 3D printing of chocolate after compounding of protein and xanthan gum in Example 16. As observed, a surface has a chocolate luster and is relatively smooth, so that a healthy, low-fat and customizable 3D printed product can be constructed under the premise of greatly reducing the content of fat in chocolate.

### Example 17

A method for preparing W/O/W fat analogue based on nanoscale pea protein includes the following steps:
(1) preparing a pea protein isolate solution with a mass concentration of 10% by using a phosphate buffer as a solvent, performing full stirring at 300 rpm for 2 h, adjusting the pH value to 6.7, and placing the solution in a refrigerator for refrigeration at 4° C. for 12 h to obtain a pea protein isolate solution;
(2) subjecting the hydrated pea protein isolate solution obtained in step (1) to high-speed shearing (treated at 10,000 rpm for 2 min) and high pressure homogenization (treated at 100 MPa for 3 min) to obtain a nanoscale pea protein isolate dispersion solution;
(3) heating the pea protein isolate dispersion solution in step (2) in a water bath pot at 80° C. for 20 min, and then performing cooling to 40° C. to obtain a modified pea protein isolate dispersion solution;
(4) adding 15 U/g of transglutaminase (TGase) into the pea protein isolate dispersion solution in step (3), adjusting the pH value to 7, performing enzymatic crosslinking in a water bath pot at 40° C. for 2 h, and finally performing heating in a water bath pot at 90° C. for 50 min to obtain a pea protein isolate gel;
(5) adding 2 times a mass of a phosphate buffer into the protein isolate gel in step (4), and performing high pressure homogenization (treated at 100 MPa for 2 min) to obtain a nanoscale pea protein microgel solution;
(6) adding 10 mL of a nanogel particle dispersion solution obtained in step (5) into 90 mL of soybean oil, and performing high-speed shearing treatment (treated at 12,000 rpm for 2 min) to obtain a W/O emulsion system, where the soybean oil accounts for 90% of a mass of the nanoscale microgel solution, and a mass concentration of the pea protein in the whole system is 1%;
(7) mixing 40, 50, 60 and 70 mL of the W/O emulsion obtained in step (6) with 30 mL of the nanoscale microgel particle dispersion solution in step (5), respectively, and performing high-speed shearing (treated at 10,000 rpm for 1 min) to obtain double-emulsified W/O/W fat analogue, where a proportion of an oil phase in the emulsion system is 36%, 54%, 45% and 63% respectively.

### Example 18 Optimization of Different Oil Phase Proportions

A method for achieving dual-channel 4D printing of multi-structure and low-fat chocolate by induced deformation includes the following steps:

(1) preparation of a first (low-melting-point) chocolate paste:
dissolving 8.75 g of the W/O/W fat analogue with different oil phase proportions in Example 17 and 26.25 g of cocoa butter in a water bath pot, performing even mixing with 20 g of cocoa powder, 44.5 g of powdered sugar and 0.5 g of soybean lecithin, and performing fine grind continuously at 1,200 rpm for 3 h by a ball mill to obtain the first (low-melting-point) chocolate paste;

(2) preparation of a second (high-melting-point) chocolate paste:
dissolving 17.5 g of the W/O/W fat analogue with different oil phase proportions in Example 17 and 17.5 g of cocoa butter in a water bath pot, performing even mixing with 20 g of cocoa powder, 44.5 g of powdered sugar and 0.5 g of soybean lecithin, and performing fine grind continuously at 1,200 rpm for 3 h by a ball mill to obtain the second (high-melting-point) chocolate paste;

(3) 4D printing:
filling the first chocolate paste into a 100 mL first printing tube, and filling the second chocolate paste into a 100 mL second printing tube;
adjusting the temperature in a printing chamber to 25° C., selecting a 3D printing gun head with a diameter of 1.2 mm for filling, and adjusting X, Y and Z axes of a 3D printer to zero by program setting;
designing a 3D model by using 3Dmax software, where an internal chocolate structure is heart-shaped, an external chocolate structure is a cuboid structure with a heart-shaped hollowed-out middle, that is to say, the external structure is printed with the low-melting-point chocolate paste by the first printing tube, and an internal embedded part is filled and printed with the high-melting-point chocolate paste by the second printing tube; generating 24 layers of corresponding three-dimensional slices by slicing software to obtain a slice model; calculating a path of each layer of slice by using programming G codes, and finally inputting the path to a printing device;
setting various parameters in a printing process, which are specifically as follows: a printing layer thickness is 1.1 mm, a wall thickness is 1.2 mm, a filling density is 50%, a bottom and top layer thickness is 1.2 mm, a printing rate is 80 mm/s, a printing temperature is 30° C., an initial layer thickness is 1.2 mm, an initial layer line width is 10%, a bottom layer cut thickness is 0 mm, a moving rate is 60 mm/s, a bottom layer rate is 60 mm/s, a filling rate is 60 mm/s, a bottom and top layer rate is 60 mm/s, a shell rate is 40 mm/s, and an inner wall rate is 80 mm/s;
performing dual-channel 3D printing by the device according to the imported slice model to form a multi-layer and multi-structure dark chocolate model constructed with two materials having different melting points;
placing the chocolate model in a stable environment at a constant temperature of 35° C. for induction for 60 s to achieve spontaneous structural changes, namely 4D printing effects, of inner and outer layers of chocolate.

Properties of obtained 4D printed chocolates prepared from the W/O/W fat analogue with different oil phase proportions were tested, and test results are as follows.

TABLE 3
Property parameters of 4D printed chocolates prepared from
W/O/W fat analogue with different oil phase proportions

| | | | Initial melting | |
|---|---|---|---|---|
| Oil phase | Hardness at 20° C. | Hardness at 37° C. | temperature | Maximum melting |
| proportion | (N) | (N) | (° C.) | temperature (° C.) |
| 36% | 429.1 ± 23.1 | 12.5 ± 0.4 | 30.6 ± 4.4 | 35.4 ± 1.5 |
| 45% | 431.8 ± 57.6 | 24.7 ± 1.5 | 31.2 ± 0.9 | 37.3 ± 1.2 |
| 54% | 497.5 ± 69.4 | 26.9 ± 2.1 | 32.7 ± 2.3 | 37.6 ± 2.6 |
| 63% | 471.5 ± 111.8 | 30.0 ± 4.8 | 34.1 ± 3.8 | 38.0 ± 1.9 |

Note:
The hardness of chocolate at 20° C. is obtained under normal temperature conditions, and the hardness of chocolate at 37° C. is obtained under simulated human oral temperature conditions.

As can be seen from Table 3, with increase of the oil phase proportion, a 4D printed chocolate system prepared from the W/O/W fat analogue with a higher oil phase proportion has higher hardness and a higher melting point. It is indicated that the chocolate is more stable under high temperature conditions by adding the liquid vegetable oil. However, one the one hand, a higher oil phase is difficult to stabilize, and on the other hand, loss of chocolate properties may be caused.

FIG. 16 shows physical images printed in Example 18. As can be seen from FIG. 16, chocolate with a lower oil phase proportion has a smoother surface, and the added W/O/W fat analogue affects surface properties of the 4D printed chocolate to a certain extent.

FIG. 17 shows a Tai Ji image and a school badge model of Jiangnan University obtained by printing low-fat chocolate constructed with fat analogue with an oil phase proportion of 54%. As can be seen from FIG. 17, surfaces are smooth, and textures are clear.

As can be seen by combining Table 3, FIG. 16 and FIG. 17, under the premise that structure molding of chocolate in 4D printing can be ensured based on melting point differences, the chocolate with an oil phase proportion of 54% has highest hardness at low temperature (20° C.) and low hardness at 37° C., but can also maintain structural changes during 4D printing, which is a preferred group in an oil phase proportion system.

### Example 19 Optimization of the Substitute Proportion

The oil phase proportion of the W/O/W fat analogue used in steps (1) and (2) in Example 18 was adjusted to 54%.

Meanwhile, the amount ratio of the W/O/W fat analogue and the cocoa butter in step (1) was adjusted, as shown in Table 4, other conditions were consistent with those in Example 18, and 4D printed chocolates were obtained.

Properties of the obtained 4D printed chocolates were tested, and test results are as follows.

TABLE 4
Property parameters of 4D printed chocolates with
different cocoa butter substitute proportions

| | | | | | Maximum |
|---|---|---|---|---|---|
| | | | | Initial melting | melting |
| W/O/W fat | Cocoa | Hardness at | Hardness at | temperature | temperature |
| analogue | butter | 20° C. (N) | 37° C. (N) | (° C.) | (° C.) |
| 0 | 35 | 491.5 ± 103.4 | 1.3 ± 0.4 | 28.6 ± 3.3 | 34.6 ± 4.2 |
| 8.75 | 26.25 | 497.5 ± 69.4 | 26.9 ± 2.1 | 32.7 ± 2.3 | 37.6 ± 2.6 |
| 17.5 | 17.5 | 496.7 ± 58.8 | 66.9 ± 10.6 | 34.0 ± 1.1 | 38.6 ± 2.0 |
| 26.25 | 8.75 | 501.8 ± 94.2 | 97.1 ± 8.9 | 34.3 ± 0.2 | 38.3 ± 1.2 |
| 35 | 0 | 630.1 ± 116.5 | 486.7 ± 30.8 | 35.6 ± 0.9 | 40.6 ± 2.7 |

Note:
The hardness of chocolate at 20° C. is obtained under normal temperature conditions, and the hardness of chocolate at 37° C. is obtained under simulated human oral temperature conditions.

As can be seen from Table 4, the W/O/W fat analogue with a higher cocoa butter substitute proportion has higher hardness at 20° C. and 37° C. and gradually increased melting point. Because of the thermodynamic stability of the W/O/W fat analogue, the melting point and the hardness are obviously improved after the cocoa butter is substituted.

FIG. 18 shows physical images printed in Example 19. As can be seen from FIG. 18, the substitute degree of the W/O/W fat analogue for the cocoa butter has no obvious effect on surface properties of a paste, and a stable self-supporting structure can be formed in a printing process.

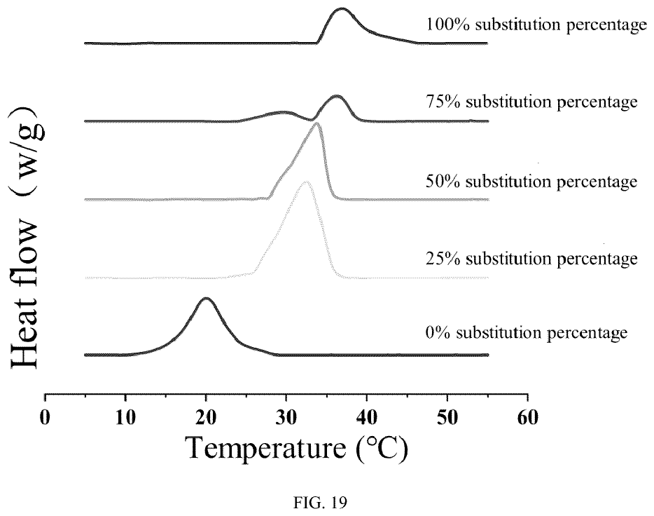

FIG. 19 shows analysis of thermodynamic properties of different 3D printed chocolates constructed at different cocoa butter substitute proportions by using DSC. As can be seen from FIG. 19, with increase of the cocoa butter substitute proportion, enthalpy change in a heating process is gradually reduced, and a heat absorption peak shifts to the left. Because the total enthalpy change is reduced due to decrease of the content of cocoa butter with crystallization properties in the inside and the melting point is increased due to thermal stability of the added W/O/W fat analogue, the heat absorption peak shifts to the left.

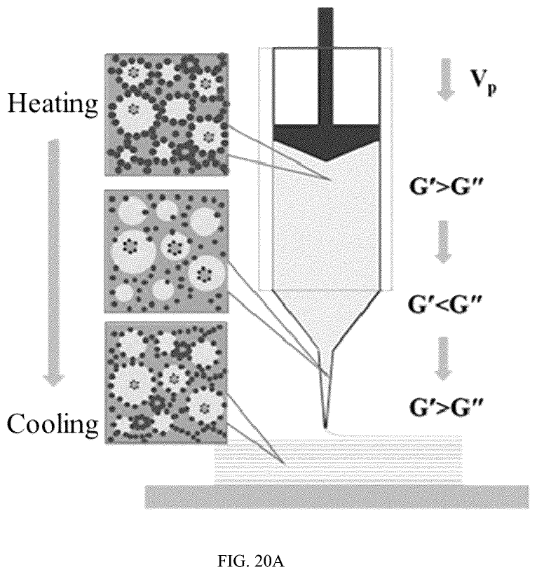

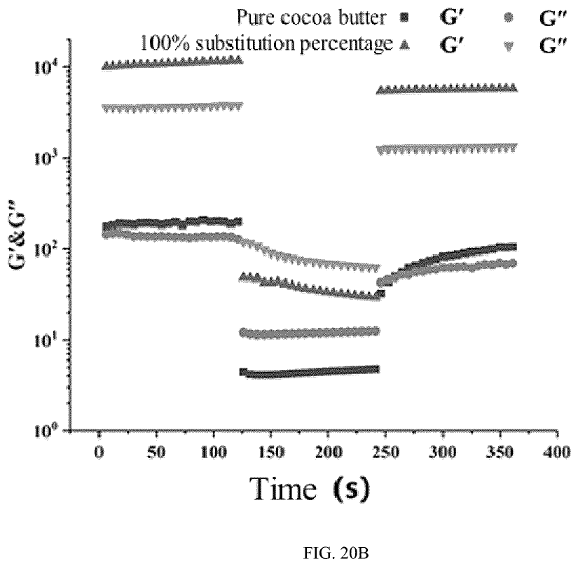

FIG. 20A-20B shows a printing mechanism diagram (FIG. 20A) and rheological property changes (FIG. 20B) when the cocoa butter substitute proportion is 0% and 100% in Example 19. FIG. 20A shows a schematic diagram of a chocolate paste from a needle cylinder to a needle and then to a loading surface in a 3D printing process, where rheological properties of the chocolate paste are shown as solid properties in the needle cylinder, fluid properties are shown due to shear thinning at the needle, and solid properties are shown again after standing on the loading surface. FIG. 20B shows simulated deformation of a chocolate paste due to the influence of a shear force in a printing process. As can be seen, the chocolate paste has solid properties when the loss modulus is smaller than the storage modulus at low shear stress (0-120 s), fluid properties are shown when the loss modulus is greater than the storage modulus at increased shear stress (120-240 s), and finally, the chocolate system is gradually restored to a solid state after the shear force is restored to lower conditions. That is to say, the processes are simulated that the chocolate paste, initially staying in a solid state in the needle cylinder, is changed into a fluid and flows through the needle under a shear force applied by pressure extrusion, then the chocolate paste is static on a loading plate, the applied shear force is removed, and the chocolate paste is restored to the solid state again.

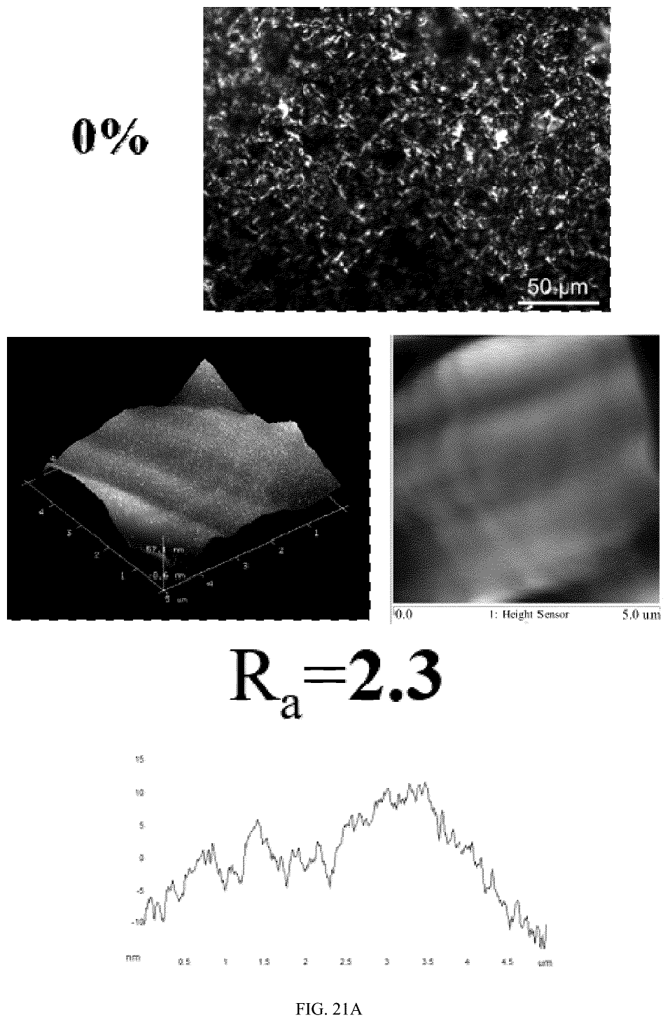

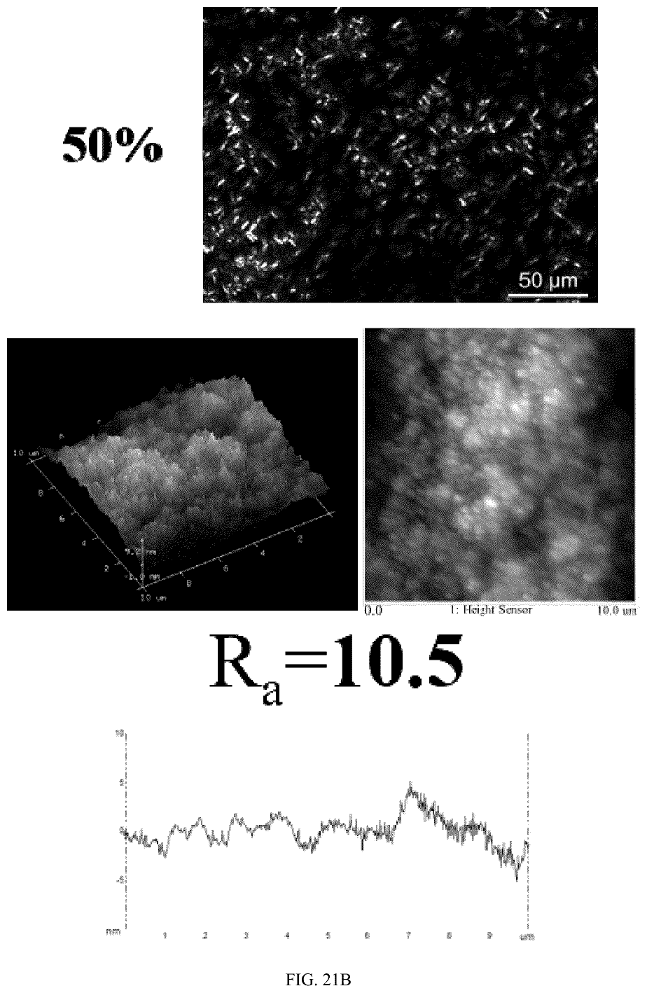

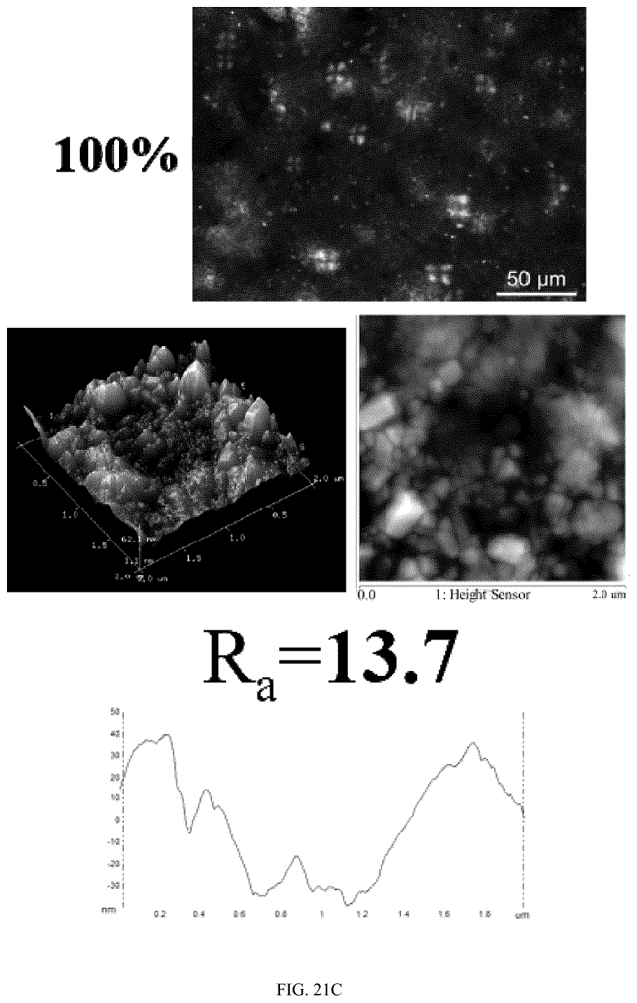

FIG. 21A-21C shows surface roughness of printed chocolates under observation of an atomic force microscope. As can be seen from FIG. 21A-21C, the surface roughness is higher when the added proportion of the W/O/W fat analogue in a system is higher, because the W/O/W lipid system affects surface crystallization properties of cocoa butter.

### Example 20

The oil phase proportion of the W/O/W fat analogue used in steps (1) and (2) in Example 18 was adjusted to 54%.

Meanwhile, the amount of the W/O/W fat analogue and the cocoa butter in step (1) was adjusted to 0 g and 35 g, respectively, and that is to say, the substitute proportion in the first (low-melting-point) paste was 0%. The amount of the W/O/W fat analogue and the cocoa butter in step (2) was adjusted to 17.5 g and 17.5 g, respectively, and that is to say, the substitute proportion in the second (high-melting-point) paste was 50%. Other conditions were consistent with those in Example 18, and 4D printed chocolates were obtained.

Properties of the obtained 4D printed chocolates were tested, and test results are as follows.

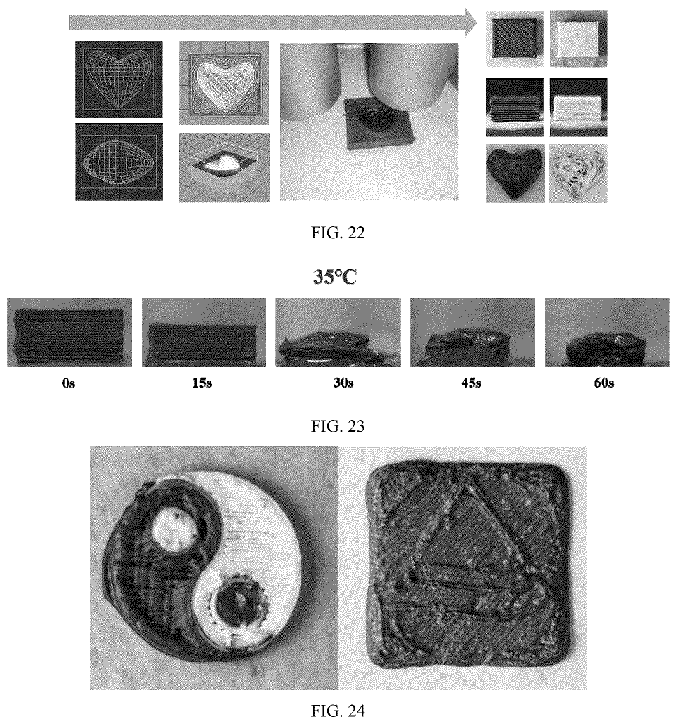

FIG. 22 shows a dual-channel multi-layer printing process in Example 20. From left to right, the process sequentially includes: constructing a model with a hollowed-out shell and an internal embedded part; then exporting a slice structure after combining two models respectively by adjusting slice parameters; importing the slice structure to a dual-channel printer for structural printing, where high-melting-point chocolate with a cocoa butter substitute proportion of 50% is obtained in an inner layer, and low-melting-point chocolate with a cocoa butter substitute proportion of 0% is obtained in an outer layer; and finally, obtaining an embedded structure with a low melting point in the outer layer and a high melting point in the inner layer.

FIG. 23 shows spontaneous structural changes, namely 4D printing, of the low-fat chocolate with a cocoa butter substitute proportion of 0% in the outer layer and a cocoa butter substitute proportion of 50% in the inner layer in an environment at 35° C. within 60 s in Example 20. As can be seen from FIG. 23, the outer layer is basically completely melted in an environment at 35° C. within 60 s due to the low melting point, while the inner layer can still achieve a stable self-supporting structure in an environment at 35° C. within 60 s as the melting point is increased by using the W/O/W fat analogue to substitute 50% of the cocoa butter.

### Example 21 Selection of Cocoa Butter

The cocoa butter used in steps (1) and (2) in Example 18 was changed into candle nut oil, illipe butter and mango kernel oil, other conditions were consistent with those in Example 18, and 4D printed chocolates were obtained.

Properties of the obtained 4D printed chocolates were tested, and test results are as follows.

TABLE 5
Property parameters of 4D printed chocolates prepared from cocoa
butter and different types of cocoa butter equivalents

| | | | Initial melting | |
|---|---|---|---|---|
| Cocoa butter | Hardness at 20° C. | Hardness at | temperature | Maximum melting |
| (equivalent) | (N) | 37° C. (N) | (° C.) | temperature (° C.) |
| Cocoa butter | 497.5 ± 69.4 | 26.9 ± 2.1 | 32.7 ± 2.3 | 37.6 ± 2.6 |
| Candle nut oil | 439.8 ± 53.2 | 13.5 ± 2.3 | 36.7 ± 2.1 | 43.8 ± 2.2 |
| Illipe butter | 498.5 ± 35.6 | 17.2 ± 0.6 | 35.9 ± 1.7 | 41.2 ± 1.9 |
| Mango kernel | 416.7 ± 23.5 | 14.6 ± 1.8 | 33.4 ± 0.8 | 37.5 ± 3.1 |
| oil | | | | |

Note:
The hardness of chocolate at 20° C. is obtained under normal temperature conditions, and the hardness of chocolate at 37° C. is obtained under simulated human oral temperature conditions.

As can be seen from Table 5, the cocoa butter equivalents have smaller hardness than the cocoa butter and equivalent melting temperature to the cocoa butter.

### Comparative Example 8

The grinding with the ball mill in Example 18 was changed into treatment with a blade stirrer at 1,200 rpm for 1 h, other conditions were consistent with those in Example 18, and dual-channel printed chocolate was obtained.

Results are shown in FIG. 24. As can be seen from FIG. 24, compared with Example 18, an obtained chocolate model has an obviously rough surface and an unclear texture. Due to the lack of grinding with the ball mill, a chocolate paste obtained by stirring with a blade still has a large number of rough particles, and the surface is rough and lack of texture due to aggregation and crystallization of the particles on the surface.

### Comparative Example 9

The temperature in the printing chamber in step (3) in Example 18 was changed into 35° C., other conditions were consistent with those in Example 18, and 4D printed chocolate was obtained.

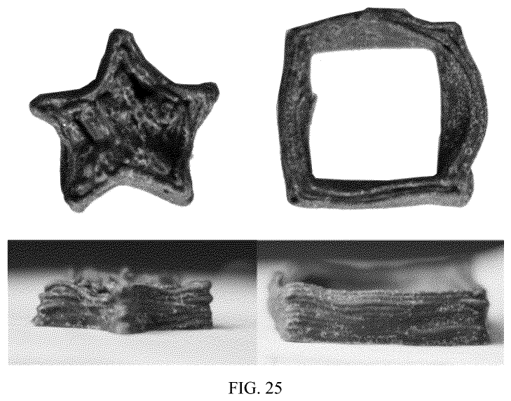

Results are shown in FIG. 25. As can be seen from FIG. 25, a structure of a chocolate model collapses to a certain extent, rheological properties of the chocolate are changed by printing in an environment at 35° C., and the fluidity is improved, so that the structure is unstable in a printing process, and a dense self-supporting structure is difficult to form.

What is claimed is:

1. A method, comprising the following steps:
(1) preparing a protein isolate solution with a mass concentration of 5-20%, and performing hydration to obtain a hydrated protein isolate solution, wherein the protein isolate is a pea protein isolate or a mung bean protein isolate;
(2) subjecting the hydrated protein isolate solution obtained in step (1) to high-speed shearing and high-pressure homogenization to obtain a nanoscale protein isolate dispersion solution;
(3) subjecting the nanoscale protein isolate dispersion solution in step (2) to heating treatment to obtain a modified protein isolate dispersion solution;
(4) adding transglutaminase (TGase) into the modified protein isolate dispersion solution in step (3) to carry out a reaction so as to obtain a protein isolate gel;
(5) adding a diluent into the protein isolate gel in step (4), and performing microfluidization and high-pressure homogenization to obtain a nanoscale microgel solution.

2. The method according to claim 1, further comprising: (6) adding a nanoscale microgel solution obtained in step (5) into an edible oil, and performing high-speed shearing treatment to obtain a gelatinized fat substitute; wherein in step (6), the edible oil comprises one or more of soybean oil, rapeseed oil, peanut oil, sunflower oil, rice bran oil, corn oil, linseed oil, olive oil, wheat germ oil, cottonseed oil, almond oil, tea seed oil and sesame oil, and a mass percentage of the edible oil in the nanoscale microgel solution obtained in step (5) is 10-90%; and wherein in step (5), the diluent comprises one or both of a phosphate buffer and water.

3. The method according to claim 1, wherein in step (2), the high-speed shearing is performed at 5,000-15,000 rpm for 1-3 minutes, and the high pressure homogenization is performed at 20-100 MPa for 1-4 minutes; in step (4), an added amount of the transglutaminase (Tgase) is 2-10 U/g, and reaction conditions comprise: low temperature crosslinking at 30-45° C. for 2-4 hours, and then heating in a water bath at 85-100° C. for 5-20 minutes to obtain a protein gel; and in step (5), the microfluidization is performed at 20-200 Mpa for 2-4 minutes, and the high pressure homogenization is performed at 60-100 Mpa for 1-4 minutes.

4. The method according to claim 1, further comprising:
(6) preparing an edible gum solution with a mass concentration of 0.02-1%;
(7) mixing a nanoscale microgel solution obtained in step (5) with the edible gum solution obtained in step (6), and performing dilution and shearing treatment to obtain a preliminary mixing system of pea/mung bean nanogel particles and edible gum; and then treating the preliminary mixing system of nanogel particles and edible gum by microfluidization or high-pressure homogenization to obtain a nanogel particle-edible gum dispersion system;
(8) adding the nanogel particle-edible gum dispersion system obtained in step (7) into an edible oil, and performing high-speed shearing treatment to obtain a gelatinized fat substitute.

5. The method according to claim 4, wherein in step (6), the edible gum is obtained by compounding one or more of guar gum, Arabic gum, carrageenan, xanthan gum and locust bean gum; and a solvent of the edible gum solution is water.

6. The method according to claim 1, further comprising:
(6) adding a nanoscale microgel solution obtained in step (5) into liquid edible vegetable oil, and performing high-speed shearing treatment to obtain a W/O system emulsion, wherein the liquid edible vegetable oil is a continuous phase, and the nanoscale microgel solution is a dispersed phase;
(7) performing secondary emulsification by using the W/O emulsion obtained in step (6) as a whole as a dispersed phase and the nanoscale microgel solution obtained in step (5) as a continuous phase, and performing high-speed shearing treatment to obtain double-emulsified W/O/W fat analogue.

7. (canceled)

8. The method according to claim 1, further comprising:
(6) preparing a polysaccharide solution with a mass concentration of 0.02-2%;
(7) mixing a nanoscale microgel solution obtained in step (5) with the polysaccharide solution obtained in step (6), adding water for dilution, and performing treatment by a shearing machine at 5,000-15,000 rpm for 1-5 min to obtain a preliminary mixing system of protein nanogel particles and polysaccharide; and further treating the mixing system of nanogel particles and polysaccharide by microfluidization or a high pressure homogenizer at 20-80 MPa to obtain a stable protein nanogel particle-polysaccharide dispersion system;
(8) adding a protein-polysaccharide mixed solution obtained in step (7) into liquid vegetable oil, wherein a protein microgel has a mass concentration of 0.2-5%, the polysaccharide has a mass concentration of 0.01-1%, and an oil phase has a mass fraction of 70-90%; and performing high-speed shearing treatment at 5,000-15,000 rpm for 1-2 min to obtain a W/O system;
(9) performing secondary emulsification by using a W/O emulsion obtained in step (8) as a whole as a dispersed phase and the protein nanogel particle-polysaccharide dispersion system obtained in step (7) as a continuous phase, and performing high-speed shearing treatment to obtain W/O/W fat analogue.

9. (canceled)

10. (canceled)

11. The method according to claim 6, further comprising:
(a) filling the double-emulsified W/O/W fat analogue into a 3D printing needle tube to ensure that the system in the needle tube is uniform and not dispersed;
(b) adjusting the temperature in a printing chamber, selecting a 3D printing gun head for filling, and adjusting X, Y and Z axes of a 3D printer to zero by program setting;
(c) designing a 3D model by using digital model software, generating several layers of corresponding three-dimensional slices by slicing software to obtain a slice model, calculating a path of each layer of slice by using programming G codes, and finally inputting the path to a printing device;
(d) setting various parameters in a 3D printing process according to different materials and selected needle diameters;
(e) performing 3D food printing by an extrusion method using the device according to the imported slice model in step (3) to form a customized model with certain self-supporting properties.

12. The method according to claim 11, wherein in step (d), the printing parameters are specifically as follows: a printing layer thickness is 0.2-0.4 mm, a wall thickness is 0.4-1.2 mm, a filling density is 10-60%, a bottom and top layer thickness is 0.2-1.2 mm, a printing rate is 40-120 mm/s, a printing temperature is 0-30° C., an initial layer thickness is 0.2-0.8 mm, an initial layer line width is 10-80%, a bottom layer cut thickness is 0 mm, a moving rate is 20-200 mm/s, a bottom layer rate is 20-120 mm/s, a filling rate is 20-120 mm/s, a bottom and top layer rate is 20-100 mm/s, a shell rate is 20-120 mm/s, and an inner wall rate is 10-80 mm/s.

13. The method according to claim 6, further comprising:
(A) dissolving the double-emulsified W/O/W fat analogue based on vegetable protein and solid cocoa butter; and then performing mixing with cocoa powder, powdered sugar and soybean lecithin and grinding to form a stable chocolate paste system;
(B) dissolving the obtained chocolate paste, and performing 3D printing to obtain 3D printed chocolate.

14. The method according to claim 13, wherein, in step (A), a mass ratio of the double-emulsified W/O/W fat analogue to the cocoa butter is (0-100%):(0-100%), further preferably (50-75%):(25-50%).

15. (canceled)

16. The method according to claim 6, further comprising:
(A) preparation of a first chocolate paste:
evenly mixing the W/O/W fat analogue with cocoa butter, a cocoa butter equivalent or a cocoa butter substitute at a mass ratio of 1:(1.1-10); and then adding an auxiliary material, and performing grinding to obtain a first paste system;
(B) preparation of a second chocolate paste:
evenly mixing the W/O/W fat analogue with cocoa butter, a cocoa butter equivalent or a cocoa butter substitute at a mass ratio of 1:(0.1-1); and then adding an auxiliary material, and performing grinding to obtain a second paste system;
(C) 4D printing:
filling the first chocolate paste into a printing tube, filling the second chocolate paste into another printing tube, and performing dual-channel printing to obtain a chocolate model; and placing the chocolate model in an environment for thermally induced deformation at 30-36° C. for 30-120 s to achieve melting of chocolate in an outer layer so as to achieve 4D printing.

17. The method according to claim 16, wherein in step (A), the first chocolate paste is a low-melting-point chocolate paste with a melting point range of 26-32° C.; the auxiliary material comprises cocoa powder/milk powder, powdered sugar and soybean lecithin; and a mass ratio of the cocoa butter, the cocoa butter equivalent or the cocoa butter substitute in the first chocolate paste, the cocoa powder/milk powder, the powdered sugar and the soybean lecithin is 1:(0.05-0.2):(0.1-0.5):(0.001-0.01).

18. The method according to claim 16, wherein in step (B), the second chocolate paste is a high-melting-point chocolate paste with a melting point range of 33-38° C.; the auxiliary material comprises cocoa powder, powdered sugar and soybean lecithin; and a mass ratio of the cocoa butter, the cocoa butter equivalent or the cocoa butter substitute in the second chocolate paste, the cocoa powder, the powdered sugar and the soybean lecithin is 1:(0.4-2):(0.5-3):(0.001-0.1).

19. The method according to claim 16, wherein in steps (A) and (B), the cocoa butter equivalent comprises one or more of shea butter, sal fat, mango kernel fat, kokum kernel fat, palm midfraction and illipe butter; and the cocoa butter substitute comprises one or both of a lauric acid cocoa butter substitute and a non-lauric acid cocoa butter substitute.

20. The method according to claim 16, wherein a printing chamber in the dual-channel printing has a temperature of 0-40° C.

21. (canceled)

22. The method according to claim 8, further comprising:
(a) filling the double-emulsified W/O/W fat analogue into a 3D printing needle tube to ensure that the system in the needle tube is uniform and not dispersed;
(b) adjusting the temperature in a printing chamber, selecting a 3D printing gun head for filling, and adjusting X, Y and Z axes of a 3D printer to zero by program setting;
(c) designing a 3D model by using digital model software, generating several layers of corresponding three-dimensional slices by slicing software to obtain a slice model, calculating a path of each layer of slice by using programming G codes, and finally inputting the path to a printing device;
(d) setting various parameters in a 3D printing process according to different materials and selected needle diameters;
(e) performing 3D food printing by an extrusion method using the device according to the imported slice model in step (3) to form a customized model with certain self-supporting properties.

23. The method according to claim 22, wherein in step (d), the printing parameters are specifically as follows: a printing layer thickness is 0.2-0.4 mm, a wall thickness is 0.4-1.2 mm, a filling density is 10-60%, a bottom and top layer thickness is 0.2-1.2 mm, a printing rate is 40-120 mm/s, a printing temperature is 0-30° C., an initial layer thickness is 0.2-0.8 mm, an initial layer line width is 10-80%, a bottom layer cut thickness is 0 mm, a moving rate is 20-200 mm/s, a bottom layer rate is 20-120 mm/s, a filling rate is 20-120 mm/s, a bottom and top layer rate is 20-100 mm/s, a shell rate is 20-120 mm/s, and an inner wall rate is 10-80 mm/s.

24. The method according to claim 8, further comprising:
(A) dissolving the double-emulsified W/O/W fat analogue based on vegetable protein and solid cocoa butter; and then performing mixing with cocoa powder, powdered sugar and soybean lecithin and grinding to form a stable chocolate paste system;
(B) dissolving the obtained chocolate paste, and performing 3D printing to obtain 3D printed chocolate.
